(19) United States
(12) Patent Application Publication
(10) Pub. No.: US 2025/0294069 A1
(43) Pub. Date: Sep. 18, 2025

(54) RESTORATION OF MULTICAST OR BROADCAST SESSION

(71) Applicant: Telefonaktiebolaget LM Ericsson (publ), Stockholm (SE)

(72) Inventors: Yong YANG, Kållered (SE); Juying GAN, Shanghai (CN); Jie LING, Shanghai (CN)

(21) Appl. No.: 18/861,301

(22) PCT Filed: Apr. 27, 2023
(86) PCT No.: PCT/CN2023/091080

§ 371 Date: Oct. 29, 2024

(30) Foreign Application Priority Data
May 4, 2022 (WO) PCT/CN2022/090851

(51) Int. Cl. H04L 65/611; H04W 76/19

(52) U.S. Cl. CPC H04L 65/611; H04W 76/19

(57) ABSTRACT

The present disclosure is related to network nodes and methods for restoration of a multicast or broadcast session. A method at an AMF for facilitating an MB-SMF in attempting a multicast session signaling for a multicast session or a broadcast session signaling for a broadcast session includes: determining whether the AMF fails to contact one or more RAN nodes for the multicast or broadcast session or not; and transmitting, to the MB-SMF, a first message indicating at least one first RAN node of the one or more RAN nodes in response to determining that the AMF fails to contact the at least one first RAN node for the multicast or broadcast session.

### CROSS-REFERENCE TO RELATED APPLICATION(S)

This application a 35 U.S.C. § 371 national stage application of PCT International Application No. PCT/CN2023/091080 filed on Apr. 27, 2023, which in turn claims priority to the PCT International Application No. PCT/CN2022/090851, filed on May 4, 2022, which are incorporated herein by reference in their entirety.

### TECHNICAL FIELD

The present disclosure is related to the field of telecommunications, and in particular, to network nodes and methods for restoration of a multicast or broadcast session.

### BACKGROUND

Broadcast services, with a scheduled programming, constitute a paramount telecommunication service for today's society. Broadcast is a transport technology to deliver the same content to an unlimited number of devices with a defined quality of service (QOS), without increasing substantially network capacity requirements, energy consumption, or costs. Cellular systems are commonly used for unicast transmissions. In this mode, a dedicated channel is established with each UE. In scenarios with a large number of users or devices consuming the same data, the use of broadcast or multicast transmission can offer substantial capacity gains, ensuring a cost-effective and high-quality delivery mechanism.

At unicast transmission, required radio resources grow linearly with the number of UEs receiving the same data. Resource allocation efficiency is improved by simultaneous transmission of data to a set of users. Via broadcast services, all users receive the same information within the service area. In multicast services, users have to subscribe to the specific service before they can receive the information. While broadcast communication is unidirectional, multicast users can establish a return channel allowing interactivity with the network. This return channel can also be used to subscribe to the desired service.

Although the existing technology is mature, current broadcast systems have serious limitations when providing service to moving users or users located in areas with complex orography and poor signal quality. To overcome these limitations, 3rd Generation Partnership Project (3GPP) 5G standard has included a work item to support 5G multicast/broadcast services for Release 17. This will bring the wide flexibility and efficiency of 5G networks to broadcasting services to greatly improve user experience while reducing operational costs. In addition, 5G broadcast/multicast services can complement conventional broadcasting technology which has severe deficiencies in some scenarios like mobility or users in remote areas.

### SUMMARY

However, there is lack of a mechanism to enable an Access and Mobility Management Function (AMF) to report a “not-reachable” failure associated with one or more Next Generation Radio Access Networks (NG-RANs) as part of Multicast/Broadcast Service (MBS) service Area during an MBS session start/release/update/activation/deactivation procedure to a Multicast/Broadcast Session Management Function (MB-SMF), therefore it is even not possible to take any remedy action to solve it. Further, it is unclear which AMF pertaining to a same AMF set (as the one previously handling a broadcast MBS session) will be responsible to restore the broadcast MBS session when the AMF which was handling the establishment of the broadcast MBS session or the last update of the broadcast MBS session has failed prior to an NG-RAN failure.

According to a first aspect of the present disclosure, a method at an AMF for facilitating an MB-SMF in attempting a multicast session signaling for a multicast session or a broadcast session signaling for a broadcast session is provided. The method comprises: determining whether the AMF fails to contact one or more Radio Access Network (RAN) nodes for the multicast or broadcast session or not; and transmitting, to the MB-SMF, a first message indicating at least one first RAN node of the one or more RAN nodes in response to determining that the AMF fails to contact the at least one first RAN node for the multicast or broadcast session.

In some embodiments, before the step of determining whether the AMF fails to contact one or more RAN nodes for the multicast or broadcast session or not, the method further comprises: transmitting, to each of the one or more RAN nodes, a second message associated with the multicast or broadcast session, wherein the step of determining that the AMF fails to contact the at least one first RAN node comprises: determining that the at least one first RAN node does not respond to the second message within a period of time. In some embodiments, the step of determining that the AMF fails to contact the at least one first RAN node comprises: determining that there is a failure in a path towards the at least one first RAN node.

In some embodiments, the first message indicates at least one of: at least one identifier of the at least one first RAN node; an identifier of the multicast or broadcast session; and an indication indicating a failure in contacting the at least one first RAN node. In some embodiments, the indication further indicates at least one of: whether the AMF has detected a (re) start of a corresponding NG-RAN or not; whether the AMF has detected a failure without a restart of a corresponding NG-RAN or not; whether the AMF has failed to reach a corresponding NG-RAN when sending an NGAP MBS Session Setup Request message or not; whether the AMF has failed to reach a corresponding NG-RAN when sending an NGAP MBS Session Modification Request message or not; and whether the AMF has failed to reach a corresponding NG-RAN when sending an NGAP MBS Session Release Request message or not. In some embodiments, the method further comprises: receiving, from the MB-SMF, a third message acknowledging the first message. In some embodiments, before the step of determining whether the AMF fails to contact one or more RAN nodes for the multicast or broadcast session or not, the method further comprises: receiving, from the MB-SMF, a fourth message indicating that the AMF is to contact the one or more RAN nodes for performing an operation associated with the multicast or broadcast session. In some embodiments, the fourth message indicates at least one of: an identifier of the multicast or broadcast session; a service area associated with the multicast or broadcast session; and information associated with the multicast or broadcast session that is to be passed to the one or more RAN nodes. In some embodiments, the second message is transmitted in response to the reception of the fourth message.

In some embodiments, the method further comprises: receiving, from each of at least one second RAN node of the one or more RAN nodes, a fifth message indicating whether an operation associated with the multicast or broadcast session is successfully performed or not in response to the second message being transmitted; and transmitting, to the MB-SMF, a sixth message indicating whether the operation is successfully performed or not at least based on the fifth message. In some embodiments, the method further comprises: receiving, from the MB-SMF, a seventh message indicating one or more identifiers of one or more third RAN nodes that are to be contacted by the AMF for performing an operation associated with another multicast or broadcast session; transmitting, to each of the one or more third RAN nodes, an eighth message indicating the one or more third RAN nodes to perform the operation associated with the other multicast or broadcast session at least based on the seventh message; receiving, from at least one of the one or more third RAN nodes, at least one ninth message indicating whether the operation associated with the other multicast or broadcast session is successfully performed or not by the at least one corresponding third RAN node in response to the eighth message being transmitted; and transmitting, to the MB-SMF, a tenth message indicating whether the operation associated with the other multicast or broadcast session is successfully performed or not at least based on the ninth message. In some embodiments, the seventh message indicates at least one signalling type associated with at least one of the one or more third RAN nodes, respectively. In some embodiments, the eighth message is a request message having the type indicated by the seventh message, and/or the corresponding ninth message is a response or failure message having the type indicated by the seventh message. In some embodiments, the seventh message further indicates whether or not the multicast or broadcast session is to be released at the AMF and/or the one or more third RAN nodes.

In some embodiments, at least one of the fifth message, the sixth message, the ninth message, and the tenth message further indicates unicast Transport Network Layer (TNL) information for shared delivery of the multicast or broadcast session. In some embodiments, the multicast or broadcast session is an MBS session. In some embodiments, when the multicast or broadcast session is a broadcast MBS session, at least one of following is true: the first message is an Namf_MBSBroadcast_ContextStatusNotify Request message; the second message is one of a Broadcast Session Setup Request message, a Broadcast Session Release Request message, and a Broadcast Session Modification Request message; the third message is an Namf_MBSBroadcast_ContextStatusNotify Response message; the fourth message is one of an Namf_MBSBroadcast_ContextCreate Request message, an Namf_MBSBroadcast_ContextRelease Request message, an Namf_MBSBroadcast_ContextUpdate Request message; the fifth message is one of a Broadcast Session Setup Response message, a Broadcast Session Release Response message, and a Broadcast Session Modification Response message; the sixth message is one of an Namf_MBSBroadcast_ContextCreate Response message, an Namf_MBSBroadcast_ContextRelease Response message, an Namf_MBSBroadcast_ContextUpdate Response message; the seventh message is one of an Namf_MBSBroadcast_ContextCreate Request message, an Namf_MBSBroadcast_ContextRelease Request message, an Namf_MBSBroadcast_ContextUpdate Request message; the eighth message is one of a Broadcast Session Setup Request message, a Broadcast Session Release Request message, and a Broadcast Session Modification Request message; the ninth message is one of a Broadcast Session Setup Response message, a Broadcast Session Release Response message, and a Broadcast Session Modification Response message; and the tenth message is one of an Namf_MBSBroadcast_ContextCreate Response message, an Namf_MBSBroadcast_ContextRelease Response message, an Namf_MBSBroadcast_ContextUpdate Response message.

According to a second aspect of the present disclosure, a first network node is provided. The first network node comprises: a processor; a memory storing instructions which, when executed by the processor, cause the processor to perform the method of any of the first aspect. In some embodiments, an AMF is hosted at the first network node.

According to a third aspect of the present disclosure, a first network node is provided. The first network node comprises: a determining module configured to determine whether the AMF fails to contact one or more RAN nodes for the multicast or broadcast session or not; and a transmitting module configured to transmit, to the MB-SMF, a first message indicating at least one first RAN node of the one or more RAN nodes in response to determining that the AMF fails to contact the at least one first RAN node for the multicast or broadcast session. In some embodiments, the first network node comprises one or more further modules configured to perform the method of any of the first aspect.

According to a fourth aspect of the present disclosure, a method at an MB-SMF for attempting a multicast session signaling for a multicast session or a broadcast session signaling for a broadcast session is provided. The method comprises: receiving, from a first AMF, a first message indicating at least one first RAN node that the first AMF fails to contact for the multicast or broadcast session; determining a second AMF that belongs to a same AMF set and/or a same AMF service set as the first AMF does; and transmitting, to the second AMF, a seventh message indicating one or more identifiers of the at least one first RAN node that is to be contacted by the second AMF for performing an operation associated with the multicast or broadcast session.

In some embodiments, the first message indicates at least one of: at least one identifier of the at least one first RAN node; an identifier of the multicast or broadcast session; and an indication indicating a failure at the first AMF in contacting the at least one first RAN node. In some embodiments, the indication further indicates at least one of: whether the first AMF has detected a (re) start of a corresponding NG-RAN or not; whether the first AMF has detected a failure without a restart of a corresponding NG-RAN or not; whether the first AMF has failed to reach a corresponding NG-RAN when sending an NGAP MBS Session Setup Request message or not; whether the first AMF has failed to reach a corresponding NG-RAN when sending an NGAP MBS Session Modification Request message or not; and whether the first AMF has failed to reach a corresponding NG-RAN when sending an NGAP MBS Session Release Request message or not. In some embodiments, the seventh message is generated at least based on the received indication, such that the seventh message indicates at least one signalling type associated with the at least one first RAN node, respectively. In some embodiments, the seventh message further indicates whether or not the multicast or broadcast session is to be released at the second AMF and/or the at least one first RAN node.

In some embodiments, the method further comprises: transmitting, to the first AMF, a third message acknowledging the first message. In some embodiments, before the step of receiving the first message, the method further comprises: transmitting, to the first AMF, a fourth message indicating that the first AMF is to contact one or more RAN nodes, which comprise the at least one first RAN node, for performing the operation associated with the multicast or broadcast session. In some embodiments, the fourth message indicates at least one of: an identifier of the multicast or broadcast session; a service area associated with the multicast or broadcast session; and information associated with the multicast or broadcast session that is to be passed to the one or more RAN nodes.

In some embodiments, the method further comprises: receiving, from the first AMF, a sixth message indicating whether an operation associated with the multicast or broadcast session is successfully performed by the one or more RAN nodes or not. In some embodiments, the method further comprises: receiving, from the second AMF, a tenth message indicating whether the operation associated with the multicast or broadcast session is successfully performed by the at least one RAN node or not. In some embodiments, at least one of the sixth message and the tenth message further indicates unicast TNL information for shared delivery of the multicast or broadcast session. In some embodiments, the method further comprises: communicating, with a Multicast/Broadcast User Plane Function (MB-UPF), for providing the unicast TNL information for shared delivery of the multicast or broadcast session from the MB-UPF to the one or more RAN nodes or the at least one first RAN node.

In some embodiments, the multicast or broadcast session is an MBS session. In some embodiments, when the multicast or broadcast session is a broadcast MBS session, at least one of following is true: the first message is an Namf_MBSBroadcast_ContextStatusNotify Request message; the third message is an Namf_MBSBroadcast_ContextStatusNotify Response message; the fourth message is one of an Namf_MBSBroadcast_ContextCreate Request message, an Namf_MBSBroadcast_ContextRelease Request message, an Namf_MBSBroadcast_ContextUpdate Request message; the sixth message is one of an Namf_MBSBroadcast_ContextCreate Response message, an Namf_MBSBroadcast_ContextRelease Response message, an Namf_MBSBroadcast_ContextUpdate Response message; the seventh message is one of an Namf_MBSBroadcast_ContextCreate Request message, an Namf_MBSBroadcast_ContextRelease Request message, an Namf_MBSBroadcast_ContextUpdate Request message; and the tenth message is one of an Namf_MBSBroadcast_ContextCreate Response message, an Namf_MBSBroadcast_ContextRelease Response message, an Namf_MBSBroadcast_ContextUpdate Response message.

According to a fifth aspect of the present disclosure, a second network node is provided. The second network node comprises: a processor; a memory storing instructions which, when executed by the processor, cause the processor to perform the method of any of the fourth aspect. In some embodiments, an MB-SMF is hosted at the second network node.

According to a sixth aspect of the present disclosure, a second network node is provided. The second network node comprises: a receiving module configured to receive, from a first AMF, a first message indicating at least one first RAN node that the first AMF fails to contact for the multicast or broadcast session; a determining module configured to determine a second AMF that belongs to a same AMF set and/or a same AMF service set as the first AMF does; and a transmitting module configured to transmit, to the second AMF, a seventh message indicating one or more identifiers of the at least one first RAN node that is to be contacted by the second AMF for performing an operation associated with the multicast or broadcast session. In some embodiments, the second network node comprises one or more further modules configured to perform the method of any of the fourth aspect.

According to a seventh aspect of the present disclosure, a method at an AMF for facilitating an MB-SMF in restoring a broadcast session is provided. The method comprises: receiving, from the MB-SMF, an eleventh message comprising an indication that the eleventh message is to provide information associated with the broadcast session to be used only for subsequent restoration of the broadcast session when one or more RAN nodes would have restarted.

In some embodiments, the eleventh message indicates at least one of: an identifier of the broadcast session; a service area associated with the broadcast session; information required for subsequent restorations of the broadcast session; and a restoration indication indicating that the AMF is not to trigger any NG Application Protocol (NGAP) signaling to the one or more RAN nodes for restoring the broadcast session. In some embodiments, when the restoration indication is set to “true” and the service area is indicated by the eleventh message, the AMF is requested to not trigger any NGAP signaling towards one or more NG-RAN nodes covering the indicated service area. In some embodiments, the AMF and another AMF, which was used for restoration of the broadcast session, belong to a same AMF set and/or a same AMF service set. In some embodiments, the method further comprises: transmitting, to the MB-SMF, a twelfth message acknowledging the eleventh message and indicating that the AMF has taken over the broadcast session from the other AMF. In some embodiments, the broadcast session is an MBS session. In some embodiments, at least one of following is true: the eleventh message is an Namf_MBSBroadcast_ContextUpdate Request message; and the twelfth message is an Namf_MBSBroadcast_ContextUpdate Response message.

According to an eighth aspect of the present disclosure, a first network node is provided. The first network node comprises: a processor; a memory storing instructions which, when executed by the processor, cause the processor to perform the method of any of the seventh aspect. In some embodiments, an AMF is hosted at the first network node.

According to a ninth aspect of the present disclosure, a first network node is provided. The first network node comprises: a receiving module configured to receive, from the MB-SMF, an eleventh message comprising an indication that the eleventh message is to provide information associated with the broadcast session to be used only for subsequent restoration of the broadcast session when one or more RAN nodes would have restarted. In some embodiments, the first network node comprises one or more further modules configured to perform the method of any of the seventh aspect.

According to a tenth aspect of the present disclosure, a method at an MB-SMF for restoring a broadcast session is provided. The method comprises: determining whether a first AMF fails to serve the broadcast session; determining a second AMF to take over the broadcast session from the first AMF; and transmitting, to a second AMF, an eleventh message comprising an indication that the eleventh message is to provide information associated with the broadcast session to be used only for subsequent restoration of the broadcast session when one or more RAN nodes would have restarted.

In some embodiments, the eleventh message indicates at least one of: an identifier of the broadcast session; a service area associated with the broadcast session; information required by the second AMF for subsequent restorations of the broadcast session; and a restoration indication indicating that the second AMF is not to trigger any NGAP signaling to the one or more RAN nodes for restoring the broadcast session. In some embodiments, when the restoration indication is set to “true” and the service area is indicated by the eleventh message, the second AMF is requested to not trigger any NGAP signaling towards one or more NG-RAN nodes covering the indicated service area. In some embodiments, the first AMF and the second AMF belong to a same AMF set and/or a same AMF service set. In some embodiments, the method further comprises: receiving, from the second AMF, a twelfth message acknowledging the eleventh message and indicating that the second AMF has taken over the broadcast session from the first AMF. In some embodiments, the step of determining whether a first AMF fails to serve the broadcast session comprises: detecting whether the first AMF fails to serve the broadcast session by using a Hypertext Transfer Protocol Version 2 (HTTP/2) Ping Frame.

In some embodiments, before the step of determining whether a first AMF fails to serve the broadcast session, the method further comprises: subscribing, to a Network Repository Function (NRF), to receive a notification of a change of a profile of the first AMF, wherein the step of determining whether a first AMF fails to serve the broadcast session comprises: receiving, from the NRF, a notification of a change of the profile of the first AMF, which indicates that the first AMF fails to serve the broadcast session. In some embodiments, the broadcast session is an MBS session. In some embodiments, at least one of following is true: the eleventh message is an

Namf_MBSBroadcast_ContextUpdate Request message; and the twelfth message is an Namf_MBSBroadcast_ContextUpdate Response message.

According to an eleventh aspect of the present disclosure, a second network node is provided. The second network node comprises: a processor; a memory storing instructions which, when executed by the processor, cause the processor to perform the method of any of the tenth aspect. In some embodiments, an MB-SMF is hosted at the second network node.

According to a twelfth aspect of the present disclosure, a second network node is provided. The second network node comprises: a first determining module configured to determine whether a first AMF fails to serve the broadcast session; a second determining module configured to determine a second AMF to take over the broadcast session from the first AMF; and a transmitting module configured to transmit, to a second AMF, an eleventh message comprising an indication that the eleventh message is to provide information associated with the broadcast session to be used only for subsequent restoration of the broadcast session when one or more RAN nodes would have restarted. In some embodiments, the second network node comprises one or more further modules configured to perform the method of any of the tenth aspect.

According to a thirteenth aspect of the present disclosure, a computer program comprising instructions which, when executed by at least one processor, cause the at least one processor to carry out the method of any of the first, fourth, seventh, and tenth aspects.

According to a fourteenth aspect of the present disclosure, a carrier containing the computer program of the thirteenth aspect. In some embodiments, the carrier is one of an electronic signal, optical signal, radio signal, or computer readable storage medium.

According to a fifteenth aspect of the present disclosure, a telecommunications system for reattempting a multicast session signaling for a multicast session or a broadcast session signaling for a broadcast session is provided. The telecommunications system comprises: a first network node of any of the second and third aspects; and a second network node of any of the fifth and sixth aspects.

According to a sixteenth aspect of the present disclosure, a telecommunications system for restoring a broadcast session is provided. The telecommunications system comprises: a first network node of any of the eighth and ninth aspects; and a second network node of any of the eleventh and twelfth aspects.

With some embodiments of the present disclosure, a failure of an MBS related procedure can be avoided when there is only a local link break between one or more NG-RANs and an AMF. With some embodiments of the present disclosure, broadcast MBS session information needs not be stored in a shared memory of an AMF set, so that AMFs in the same AMF set can retrieve the broadcast MBS session information from an MB-SMF directly, since the MB-SMF will provide full broadcast MBS session information once it detects the original AMF has failed.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several embodiments in accordance with the disclosure and therefore are not to be considered limiting of its scope, the disclosure will be described with additional specificity and detail through use of the accompanying drawings.

FIG. 1 is a diagram illustrating exemplary delivery methods for an MBS session to which restoration of a multicast or broadcast session is applicable according to some embodiments of the present disclosure.

FIG. 2 is a diagram illustrating an exemplary telecommunication network in which restoration of a multicast or broadcast session is applicable according to some embodiments of the present disclosure.

FIG. 3 is a diagram illustrating another exemplary telecommunication network in which restoration of a multicast or broadcast session is applicable according to some embodiments of the present disclosure.

FIG. 4 is a diagram illustrating exemplary user plane data transmission in which restoration of a multicast or broadcast session is applicable according to some embodiments of the present disclosure.

FIG. 5 is a diagram illustrating an exemplary procedure for restoring a broadcast session via an alternative AMF according to an embodiment of the present disclosure.

FIG. 6A and FIG. 6B are diagrams illustrating an exemplary procedure for restoring from a failure associated with a multicast or broadcast session via an alternative AMF according to an embodiment of the present disclosure.

FIG. 7A and FIG. 7B are diagrams illustrating another exemplary procedure for restoring from a failure associated with a multicast or broadcast session via an alternative AMF according to another embodiment of the present disclosure.

FIG. 8 is a diagram illustrating another exemplary procedure for restoring from a failure associated with a broadcast session via an alternative AMF according to another embodiment of the present disclosure.

FIG. 9 is a flow chart of an exemplary method at an AMF for facilitating an MB-SMF in attempting a multicast session signaling for a multicast session or a broadcast session signaling for a broadcast session according to an embodiment of the present disclosure.

FIG. 10 is a flow chart of an exemplary method at an MB-SMF for attempting a multicast session signaling for a multicast session or a broadcast session signaling for a broadcast session according to an embodiment of the present disclosure.

FIG. 11 is a flow chart of an exemplary method at an AMF for facilitating an MB-SMF in restoring a broadcast session according to an embodiment of the present disclosure.

FIG. 12 is a flow chart of an exemplary method at an MB-SMF for restoring a broadcast session according to an embodiment of the present disclosure.

FIG. 13 schematically shows an embodiment of an arrangement which may be used in a network node according to an embodiment of the present disclosure.

FIG. 14 is a block diagram of an exemplary first network node according to an embodiment of the present disclosure.

FIG. 15 is a block diagram of an exemplary second network node according to an embodiment of the present disclosure.

FIG. 16 is a block diagram of another exemplary first network node according to another embodiment of the present disclosure.

FIG. 17 is a block diagram of another exemplary second network node according to another embodiment of the present disclosure.

FIG. 18 to FIG. 21 are diagrams illustrating exemplary procedures that can be applicable in restoration of a multicast or broadcast session according to some embodiments of the present disclosure.

### DETAILED DESCRIPTION

Hereinafter, the present disclosure is described with reference to embodiments shown in the attached drawings. However, it is to be understood that those descriptions are just provided for illustrative purpose, rather than limiting the present disclosure. Further, in the following, descriptions of known structures and techniques are omitted so as not to unnecessarily obscure the concept of the present disclosure.

Those skilled in the art will appreciate that the term “exemplary” is used herein to mean “illustrative,” or “serving as an example,” and is not intended to imply that a particular embodiment is preferred over another or that a particular feature is essential. Likewise, the terms “first” and “second,” and similar terms, are used simply to distinguish one particular instance of an item or feature from another, and do not indicate a particular order or arrangement, unless the context clearly indicates otherwise. Further, the term “step,” as used herein, is meant to be synonymous with “operation” or “action.” Any description herein of a sequence of steps does not imply that these operations must be carried out in a particular order, or even that these operations are carried out in any order at all, unless the context or the details of the described operation clearly indicates otherwise.

Conditional language used herein, such as “can,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment. Also, the term “or” is used in its inclusive sense (and not in its exclusive sense) so that when used, for example, to connect a list of elements, the term “or” means one, some, or all of the elements in the list. Further, the term “each,” as used herein, in addition to having its ordinary meaning, can mean any subset of a set of elements to which the term “each” is applied.

The term “based on” is to be read as “based at least in part on.” The term “one embodiment” and “an embodiment” are to be read as “at least one embodiment.” The term “another embodiment” is to be read as “at least one other embodiment.” Other definitions, explicit and implicit, may be included below. In addition, language such as the phrase “at least one of X, Y and Z,” unless specifically stated otherwise, is to be understood with the context as used in general to convey that an item, term, etc. may be either X, Y, or Z, or a combination thereof.

The terminology used herein is for the purpose of describing particular embodiments only and is not intended to be limitation of example embodiments. As used herein, the singular forms “a”, “an”, and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof. It will be also understood that the terms “connect(s),” “connecting”, “connected”, etc. when used herein, just mean that there is an electrical or communicative connection between two elements and they can be connected either directly or indirectly, unless explicitly stated to the contrary.

Of course, the present disclosure may be carried out in other specific ways than those set forth herein without departing from the scope and essential characteristics of the disclosure. One or more of the specific processes discussed below may be carried out in any electronic device comprising one or more appropriately configured processing circuits, which may in some embodiments be embodied in one or more application-specific integrated circuits (ASICs). In some embodiments, these processing circuits may comprise one or more microprocessors, microcontrollers, and/or digital signal processors programmed with appropriate software and/or firmware to carry out one or more of the operations described above, or variants thereof. In some embodiments, these processing circuits may comprise customized hardware to carry out one or more of the functions described above. The present embodiments are, therefore, to be considered in all respects as illustrative and not restrictive.

Although multiple embodiments of the present disclosure will be illustrated in the accompanying Drawings and described in the following Detailed Description, it should be understood that the disclosure is not limited to the disclosed embodiments, but instead is also capable of numerous rearrangements, modifications, and substitutions without departing from the present disclosure that as will be set forth and defined within the claims.

Further, please note that although the following description of some embodiments of the present disclosure is given in the context of 5G New Radio (5G NR), the present disclosure is not limited thereto. In fact, as long as restoration of a multicast or broadcast session are involved, the inventive concept of the present disclosure may be applicable to any appropriate communication architecture, for example, to Global System for Mobile Communications (GSM)/General Packet Radio Service (GPRS), Enhanced Data Rates for GSM Evolution (EDGE), Code Division Multiple

Access (CDMA), Wideband CDMA (WCDMA), Time Division-Synchronous CDMA (TD-SCDMA), CDMA2000, Worldwide Interoperability for Microwave Access (WiMAX), Wireless Fidelity (Wi-Fi), Long Term Evolution (LTE), etc. Therefore, one skilled in the arts could readily understand that the terms used herein may also refer to their equivalents in any other infrastructure. For example, the term “User Equipment” or “UE” used herein may refer to a mobile device, a mobile terminal, a mobile station, a user device, a user terminal, a wireless device, a wireless terminal, an IoT device, a vehicle, or any other equivalents. For another example, the term “network node” used herein may refer to or comprise a base station, a base transceiver station, an access point, a hot spot, a NodeB (NB), an evolved NodeB (eNB), a gNB, a network element, a network function (NF), or any other equivalents.

Further, following 3GPP documents are incorporated herein by reference in their entireties:
3GPP TS 23.247 V17.2.0 (2022-03), 3rd Generation Partnership Project; Technical Specification Group Services and System Aspects; Architectural enhancements for 5G multicast-broadcast services; Stage 2 (Release 17); and
3GPP TS 23.527 V17.3.1 (2022-03), 3rd Generation Partnership Project; Technical Specification Group Core Network and Terminals; 5G System; Restoration Procedures (Release 17).

It is defined in TS 23.247 v17.2.0 that:

### 3.1 Terms

. . .
Broadcast MBS session: An MBS session to deliver the broadcast communication service. A broadcast MBS session is characterized by the content to send and the geographical area where to distribute it.

3GPP TS 23.247 v17.2.0 specifies architectural enhancements to the 5G system using NR to support multicast and broadcast communication services. To be specific, 3GPP TS 23.247 v17.2.0 specifies the following.

### Overview of Multicast and Broadcast Communication

Multicast and Broadcast Service (MBS) is a point-to-multipoint service in which data is transmitted from a single source entity to multiple recipients, either to all users in a broadcast service area, or to users in a multicast group as defined in TS 22.146, v17.0.0. The corresponding types of MBS session are:
Broadcast session;
Multicast session.

The MBS architecture defined in clause 5 of 3GPP TS 23.247 v17.2.0 follows the 5G System architectural principles as defined in 3GPP TS 23.501, v17.4.0, enabling distribution of the MBS data from the 5G System (5GS) ingress to NG-RAN node(s) and then to the UE. The MBS architecture provides:
Efficient usage of RAN and Core Network (CN) resources, with an emphasis on radio interface efficiency;
Efficient transport for a variety of multicast and broadcast services.

Multicast-broadcast service for roaming is not supported in this release.

Interaction between multicast-broadcast service and support of deployments topologies with specific SMF Service Areas is not specified in this release.

The MBS also provides functionalities such as local MBS service, authorization of multicast MBS and QoS differentiation. Refer to clause 6 of 3GPP TS 23.247 v17.2.0 for more details.

MBS traffic is delivered from a single data source (e.g., Application Service Provider) to multiple UEs. Depending on many factors, there are several delivery methods which may be used to deliver the MBS traffic in the 5GS.

NOTE 1: For clarity, delivery methods are not referred to as unicast/multicast/broadcast but as described below. The term “unicast delivery” refers to a mechanism by which application data and signaling between the UE and the application server are delivered using PDU Session within the 3GPP network and using individual UE and application server addresses (e.g., IP addresses) between the 3GPP network and the application server. It is not equivalent to 5G Core (5GC) Individual MBS traffic delivery method defined in clause 4 of 3GPP TS 23.247 v17.2.0.

Between 5GC and NG-RAN, there are two possible delivery methods to transmit the MBS data:
5GC Individual MBS traffic delivery method: This method is only applied for multicast MBS session. 5GC receives a single copy of MBS data packets and delivers separate copies of those MBS data packets to individual UEs via per-UE PDU sessions, hence for each such UE one PDU session is required to be associated with a multicast session.
5GC Shared MBS traffic delivery method: This method is applied for both broadcast and multicast MBS session. 5GC receives a single copy of MBS data packets and delivers a single copy of those MBS packets to an NG-RAN node, which then delivers the packets to one or multiple UEs.

The 5GC Shared MBS traffic delivery method is required in all MBS deployments. The 5GC Individual MBS traffic delivery method is required to enable mobility when there is an NG-RAN deployment with non-homogeneous support of MBS.

For the multicast session, a single copy of MBS data packets received by the CN may be delivered via 5GC Individual MBS traffic delivery method for some UE(s) and via 5GC Shared MBS traffic delivery method for other UEs.

Between the NG-RAN and the UE, two delivery methods are available for the transmission of MBS data packets over radio interface:
Point-to-Point (PTP) delivery method: NG-RAN delivers separate copies of MBS data packets over radio interface to individual UE(s).
Point-to-Multipoint (PTM) delivery method: NG-RAN delivers a single copy of MBS data packets over radio interface to multiple UEs.

NG-RAN may use a combination of PTP/PTM to deliver MBS data packets to UEs.

NOTE 2: The PTP and PTM delivery methods are defined in RAN Working Groups (WGs).

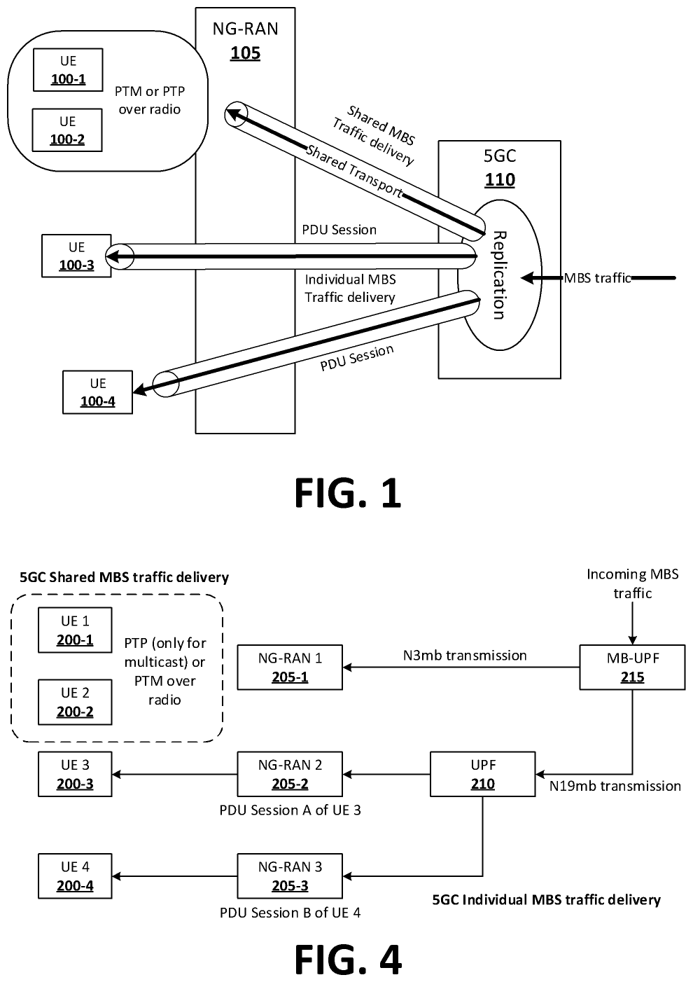

As depicted in FIG. 1, 5GC Shared MBS traffic delivery method (with PTP or PTM delivery) and 5GC Individual MBS traffic delivery method may be used at the same time for a multicast MBS session.

FIG. 1 is a diagram illustrating exemplary delivery methods for an MBS session to which restoration of a multicast or broadcast session is applicable according to some embodiments of the present disclosure. As shown in FIG. 1, multiple UEs 100-1, 100-2, 100-3, and 100-4 may join the MBS session with different delivery methods. For example, the UE 100-1 and the UE 100-2 may be served by the shared MBS traffic delivery via a shared tunnel established between an NG-RAN node 105 and a 5GC 110. In such a case, a single copy of MBS data packets may be delivered from the 5GC 110 to the NG-RAN node 105, which then delivers the packets to the UE 100-1 and UE 100-2 with PTP or PTM delivery methods. For another example, the UE 100-3 and the UE 100-4 may be served by the individual MBS traffic delivery via two separate PDU sessions established between one or more RAN nodes 105 and the 5GC 110. In such a case, separate copies of those MBS data packets may be delivered from the 5GC 110 to individual UEs 100-3 and 100-4 via per-UE PDU sessions.

For MBS broadcast communication, only 5GC Shared MBS traffic delivery method with PTM delivery is applicable.

For MBS multicast communication, if the NG-RAN node supports MBS, the network shall use the 5GC Shared MBS traffic delivery method for MBS data transmission.

NOTE 3: The exception is when the UE moves between NG-RAN node not supporting MBS (with 5GC Individual MBS traffic delivery method) and NG-RAN node supporting MBS, there is temporary co-existence between 5GC Shared MBS traffic delivery method and 5GC Individual MBS traffic delivery method. Refer to clause 6.3 of 3GPP TS 23.247 v17.2.0 for details.

For MBS multicast communication, the switching between 5GC Shared MBS traffic delivery method and 5GC Individual MBS traffic delivery method is supported. The UE mobility between RAN nodes both supporting MBS, and between a RAN node supporting MBS and a RAN node not supporting MBS is supported, for details see clause 6.3 of 3GPP TS 23.247 v17.2.0.

For MBS multicast communication, the switching between PTP and PTM delivery methods for 5GC Shared MBS traffic delivery shall be supported. NG-RAN is the decision point for switching between PTP and PTM delivery methods.

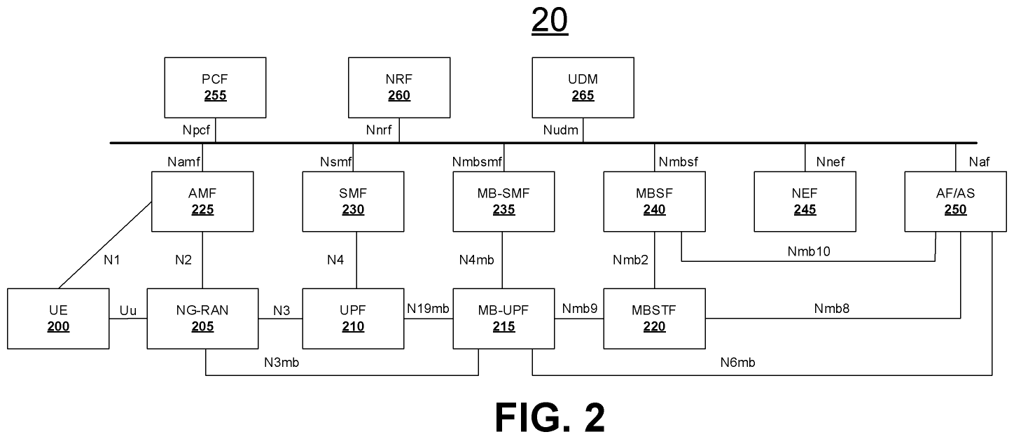

FIG. 2 is a diagram illustrating an exemplary telecommunication network 20 in which restoration of a multicast or broadcast session is applicable according to some embodiments of the present disclosure, and FIG. 2 depicts the MBS reference architecture. Service-based interfaces are used within the Control Plane. Support for interworking at reference points xMB and MB2 is described in Annex C of 3GPP TS 23.247 v17.2.0. Although the telecommunications network 20 is a network defined in the context of 5GS, the present disclosure is not limited thereto.

As shown in FIG. 2, the network 20 may comprise one or more UEs 200 and an NG-RAN 205, which could be or comprise one or more of base station, a Node B, an evolved NodeB (eNB), a gNB, or an access network (AN) node which provides the UEs 200 with access to other parts of the network 20. Further, the network 20 may comprise its core network portion comprising (but not limited to) an AMF 225, a Session Management Function (SMF) 230, a User Plane Functions (UPF) 210, a Policy Control Function (PCF) 255, a Network Exposure Function (NEF) 245, an Application Function/Application Server (AF/AS) 250, a Unified Data Management (UDM) 265, and/or an NRF 260. Further, in addition to these network functions, the telecommunication network 20 may further comprise network functions for supporting MBS, comprising (but not limited to) an MB-SMF 235, an MB-UPF 215, a Multicast/Broadcast Service Function (MBSF) 240, and a Multicast/Broadcast Service Transport Function (MBSTF) 220. As shown in FIG. 2, these entities may communicate with each other via the service-based interfaces, such as, Namf, Nsmf, Npcf, etc. and/or the reference points, such as, N1, N2, N3, N4, N3mb, N19mb, etc.

However, the present disclosure is not limited thereto. In some other embodiments, the network 20 may comprise additional network functions, less network functions, or some variants of the existing network functions shown in FIG. 2. For example, in a network with the 4G architecture, the entities which perform these functions (e.g., mobility management entity (MME)) may be different from those shown in FIG. 2 (e.g., the AMF 225). For another example, in a network with a mixed 4G/5G architecture, some of the entities may be same as those shown in FIG. 2, and others may be different. Further, the functions shown in FIG. 2 are not essential to the embodiments of the present disclosure. In other words, some of them may be missing from some embodiments of the present disclosure. The functions shown in FIG. 2 will be described in detail below.

Referring to FIG. 2, the AMF 225 may provide most of the functions that the MME provides in a 4G network as mentioned above. Below please find a brief list of some of its functions:
Terminates the RAN Control Plane (CP) interface (N2);
Non-access stratum (NAS) signaling;
NAS ciphering and integrity protection;
Mobility Management (MM) layer NAS termination;
Session Management (SM) layer NAS forwarding;
Authenticates UE 200;
Manages the security context;
Registration management;
Connection management;
Reachability management;
Mobility Management; and/or
Apply mobility related policies from PCF 255 (e.g., mobility restrictions).

In addition to the functions defined above, the AMF 225 may further perform at least one of following functions to support MBS:
Signaling with NG-RAN 205 and MB-SMF 235 for MBS Session management;
Selection of NG-RANs 205 for notification of multicast session activation toward UEs 200 in CM-IDLE state;
Selection of NG-RANs 205 for broadcast traffic distribution.

Additionally, the AMF 225 may be aware of NG-RAN 5G MBS capability.

The MB-SMF 235 may perform at least one of the following functions to support MBS:
General for multicast and broadcast sessions:
   Supporting MBS session management (including QoS control);
   Configuring the MB-UPF 215 for multicast and broadcast flows transport based on the policy rules for multicast and broadcast services from PCF 255 or local policy;
   Allocating and de-allocating Temporary Mobile Group Identity (TMGI);
Specific for broadcast sessions:
   Interacting with RAN 205 (via AMF 225) to control data transport using 5GC Shared MBS traffic delivery method;
Specific for multicast sessions:
   Interacting with SMF 230 to modify PDU Session associated with MBS session;
   Interacting with RAN 205 (via AMF 225 and SMF 230) to establish data transmission resources between MB-UPF 215 and RAN nodes for 5GC Shared MBS traffic delivery method;
   Controlling multicast data transport using 5GC Individual MBS traffic delivery method.

In addition to the functions defined in TS 23.501, v17.4.0, the NG-RAN 205 may perform at least one of the following functions to support MBS:
Management of MBS QoS flows via N2;
Delivery of MBS data packets from 5GC shared for multiple UEs 200 over radio using PTM or PTP;
Configuration of UE 200 for MBS QoS flow reception at Access Stratum (AS) layer;
Control switching between PTM and PTP delivery per UE;
Support for multicast sessions continuity during Xn Handover and N2 Handover;
Support notification of multicast session activation over radio toward UEs 200 in CM-IDLE state and CM-CONNECTED with RRC Inactive state.

In addition to the functions defined in TS 23.501, v17.4.0, the NRF 260 may further perform at least one of the following functions to support 5G MBS:
Support of new NF types MB-SMF and MBSF and their corresponding NF profiles;
For both multicast and broadcast MBS Session, support of MB-SMF discovery based on parameters such as Data Network Name (DNN), Single-Network Slice Selection Assistance Information (S-NSSAI) and MB service area, at MBS Session creation; and
For multicast MBS Session, support of MB-SMF discovery based on MBS Session ID by SMF 230 serving the multicast Session at UE join.

Please note that the MBSF 240 is optional and may be collocated with the NEF 245 or AF/AS 250, and the MBSTF 220 may be an optional network function. Further, the existing service based interfaces of Nnrf, Nudm, and Nsmf may be enhanced to support MBS. The existing service based interfaces of Npcf and Nnef may be enhanced to support MBS. An MBS enabled AF may use either Nmbsf or Nnef to interact with the MBSF.

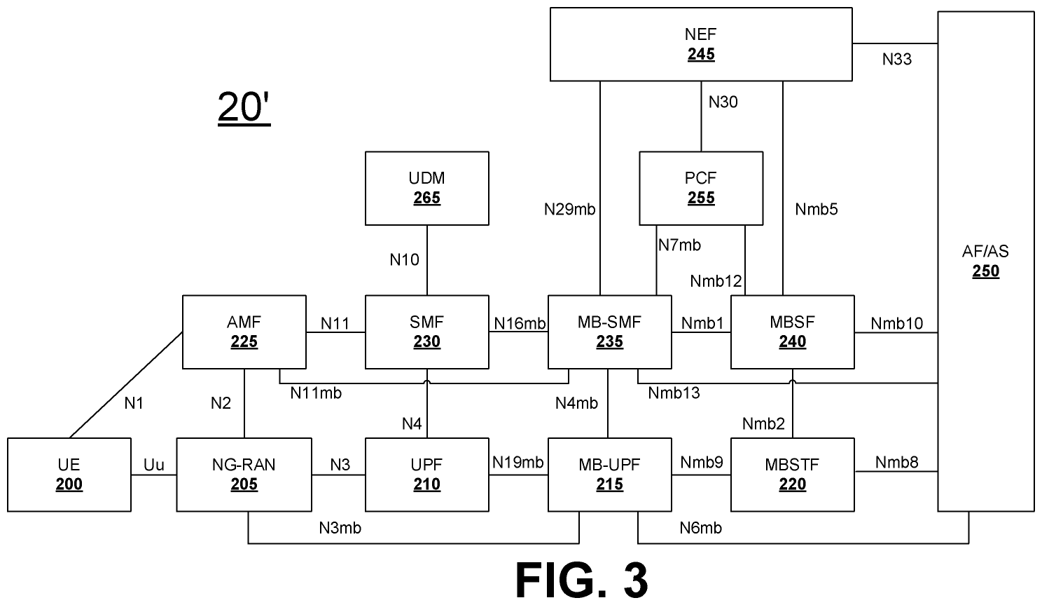

FIG. 3 is a diagram illustrating another exemplary telecommunication network 20′ in which restoration of a multicast or broadcast session is applicable according to some embodiments of the present disclosure, and FIG. 3 depicts the 5G system architecture for MBS using the reference point representation. Since the NFs shown in FIG. 3 are substantially similar to those shown in FIG. 2, and therefore detailed descriptions thereof are omitted for simplicity.

In some embodiments, the existing reference points of N1, N2, N4, N10, N11, N30 and N33 may be enhanced to support MBS. Further, regarding the functionalities, Nmb13, N29mb and Nmb1 may be identical, Nmb5 and Nmb10 may be identical, Nmb9 and N6mb may be identical.

Per 3GPP TS 23.247 v17.2.0, unicast or multicast transport over N3mb between NG-RAN and MB-UPF may be applied:
If unicast transport over N3mb is applied, each NG-RAN allocates Tunnel Info (including IP address and Tunnel Endpoint Identifier (TEID)) which is provided to MB-UPF (via AMF, MB-SMF) so that the DL MBS packet can be sent to that tunnel entity.
If multicast transport over N3mb is applied, the NG-RAN does not provide Tunnel Info, instead, the NG-RAN joins a multicast IP address provided by the MB-UPF.

The MB-UPF acts as the MBS Session Anchor of an MBS session, and if the MBSTF is involved in the MBS session, then the MBSTF acts as the media anchor of the MBS traffic. The MB-UPF receives only one copy of MBS data packets from AF or MBSTF.

The user plane between MBSTF and MB-UPF, or between MB-UPF and AF, may use either multicast transport or unicast tunnel for the MBS session (depending on application and capabilities of control interface). If the transport network does not support multicast transport, the user plane uses unicast tunnel for the MBS Session. The user plane between MBSTF and AF may use unicast tunnel, multicast transport or other means (e.g., HTTP download from external Content Delivery Network (CDN)). Unicast is used for the MBS Session, after receiving the downlink MBS data, the MB-UPF forwards the downlink MBS data without the outer IP header and tunnel header information.

The user plane from the MB-UPF to NG-RAN(s) (for 5GC Shared MBS traffic delivery) and the user plane from the MB-UPF to UPFs (for 5GC Individual MBS traffic delivery) may use multicast transport via a common General Packet Radio Service (GPRS) Tunneling Protocol-User Plane (GTP-U) tunnel per MBS session, or use unicast transport via separate GTP-U tunnels at NG-RAN or at UPF per MBS session in the following way:
For 5GC Shared MBS traffic delivery (i.e., MB-UPF delivers user plane data to NG-RAN supporting MBS), if the transport network supports IP multicast, the NG-RAN node uses multicast transport via a common GTP-U tunnel per MBS session, otherwise unicast transport via separate GTP-U tunnel per MBS session per NG-RAN node is used.
For 5GC Individual MBS traffic delivery (i.e., MB-UPF delivers user plane data to UPF), if the transport network supports IP multicast and the UPF supports reception of multicast data over N19mb, UPF uses multicast transport via a common GTP-U tunnel per MBS session, otherwise unicast transport via separate GTP-U tunnel per MBS session per UPF is used.

If the user plane uses unicast transport, the transport layer destination is the IP address of the NG-RAN or UPF, each NG-RAN or UPF allocates the tunnel separately and multiple GTP-U tunnels are used for the MBS Session. If the user plane uses multicast transport, a common GTP-U tunnel is used for both RAN and UPF nodes. The GTP-U tunnel is identified by a common tunnel ID and an IP multicast address as the transport layer destination, both assigned by 5GC.

The above is depicted in FIG. 4. There could be more than one NG-RANs or UPFs that are involved in the MBS traffic delivery. FIG. 4 is a diagram illustrating exemplary user plane data transmission in which restoration of a multicast or broadcast session is applicable according to some embodiments of the present disclosure.

Similar to those shown in FIG. 1, multiple UEs 200-1, 200-2, 200-3, and 200-4 may join an MBS session with different delivery methods. For example, the UE #1 200-1 and the UE #2 200-2 may be served by the shared MBS traffic delivery via a shared tunnel, while the UE 200-3 and the UE 200-4 may be served by the individual MBS traffic delivery via two separate PDU sessions A and B, respectively.

The MB-SMF instructs the MB-UPF to receive packets related to an MBS session.

For shared delivery (e.g., to UE #1 200-1, UE #2 200-2), if unicast transport over N3mb applies, the MB-SMF instructs MB-UPF (e.g., MB-UPF 215) to replicate the received MBS packets and forward them towards multiple RAN nodes via separate GTP tunnel. For shared delivery, if multicast transport over N3mb applies, the MB-SMF instructs the MB-UPF to replicate the received MBS data and forwards the data via a single GTP tunnel.

For individual delivery (e.g., to UE #3 200-3, UE #4 200-4), the MBS data received by the MB-UPF is replicated towards the UPF(s) (e.g., UPF 210) where individual delivery is performed in the following way:
The MB-SMF configures the MB-UPF to receive packets related to an MBS session, to replicate those packets and forward them towards multiple UPFs via GTP tunnels if unicast transport over N19mb is applied, or via a single GTP tunnel if multicast transport over N19mb is applied.
The SMF(s) instructs the UPF to receive packets related to a multicast session from an MB-UPF over N19mb, to replicate those packets and to forward them in multiple PDU sessions.

For the MB-SMF and MB-UPF, packet detection, replication and forwarding for an MBS session is realized by using for each MBS session one Packet Detection Rule (PDR) that detects the incoming MBS packets and points to one Forwarding Action Rule (FAR) that describes the forwarding of the data towards multiple destinations (UPFs or RAN nodes):
A Packet Forwarding Control Protocol (PFCP) session is created when the MBS Session is started, regardless of multicast or unicast transport over N3mb and N19mb.
For Multicast transport over N3mb and N19mb, the destination in the FAR contains the MB-UPF IP Multicast Distribution Info.
For unicast transport over N3mb and N19mb, the FAR in the PFCP session may contain multiple destinations represented by the NG-RAN N3mb Tunnel Info and UPF N19mb Tunnel Info (if applicable).

For the SMF and the UPF (for 5GC individual delivery), packet detection, replication and forwarding for an MBS session is realized by PDR and FAR of the PDU session in which the UE has joined the MBS session:
The SMF instructs the UPF to associate the PFCP session of the PDU session with an MBS session.
A new PDR with Source Interface “Core” is used to detect MBS data from N19mb.

NOTE: This PDR is also containing the MBS session ID to enable a single detection of the incoming MBS data for multiple PDU sessions at the UPF.
For unicast transport over N19mb, the SMF requests UPF to allocate N19mb Tunnel Info if not allocated.
For multicast transport over N19mb, the SMF includes the low layer source specific multicast address information and Common TEID (C-TEID) to UPF.
If the SMF wants to maintain the MBS data reception over N19mb but suspends the delivery of the data to the UE's PDU session, the Action of FAR set to “drop” (e.g., when the UE is switching from 5GC Individual delivery to 5GC Shared delivery due to the UE moving from MBS non-supporting NG-RAN to MBS supporting NG-RAN). Otherwise, the SMF removes the related PDR and FAR.

See 3GPP TS 29.244, v17.4.0 for the details of user plane handling.

3GPP TS 23.527 v17.3.1 specifies the restoration procedures in the 5G system. Next, NF Service Producer Instance Reselection will be described.

### General

An NF Instance of an NF Service Producer may expose several service instances of the same NF Service (e.g., an UDM instance may expose several service instances of the “Nudm_SubscriberDataManagement” service).

An NF Service Consumer may discover, while a Service Communication Proxy (SCP) shall be able to discover, via NRF Nnrf_NFDiscovery service, all available NF Service Instances for a given NF Service and select one of them.

NF Service Instance Reselection when a (Routing) Binding Indication is Available

When using the Binding procedures specified in clause 6.12 of 3GPP TS 29.500, v17.6.0, Binding Indications and Routing Binding Indications include the Binding level and one or more Binding entity IDs representing all NF service instances that are capable to serve service requests targeting the resource, i.e., that share the same resource contexts.

When a Binding Indication or a Routing Binding Indication is available for a target resource, NF Service Instance selection and re-selection shall be supported as specified in clause 6.12 of 3GPP TS 29.500, v17.6.0.

NF Service Instance Reselection when a (Routing) Binding Indication is Not Available

If a formerly selected NF Service Instance becomes unavailable, the NF Service Consumer may, while the SCP shall be able to select a different instance of a same NF Service in:
the same NF Instance, if the NF Instance indicates in its NF Profile that it supports the capability to persist their resources in shared storage inside the NF Instance, and if the new NF Service Instance offers the same major service version; or
the same NF Set or NF Service Set, if the NF (service) instance indicates in its NF Profile that it belongs to an NF Set or an NF Service Set.

If so, the NF Service Consumer may, while the SCP shall be able to invoke service operations in the newly selected NF Service Instance by means of replacing the addressing parameters with those of the new service instance, and the new NF Service Instance in the NF Service Producer shall produce the same result as if the service request would have been successfully delivered to the former NF Service Instance.

NOTE 1: In some scenarios, the newly selected NF Service Producer might not produce the exact same result as the former NF Service Producer would have produced for the service request, e.g., when the former NF Service Producer failed before it could update a change in the resource context to the Unstructured Data Storage Function (UDSF).

For indirect communication, if the NF service consumer delegates target NF service instance reselection to the SCP (when the target NF service instance is not reachable), the NF Service Consumer shall include at least one of the 3gpp-Sbi-Discovery-target-nf-instance-id, 3gpp-Sbi-Discovery-target-nf-set-id, 3gpp-Sbi-Discovery-target-nf-service-set-id, 3gpp-Sbi-Discovery-amf-region-id and 3gpp-Sbi-Discovery-amf-set-id headers, and it should also include at least the following information in its request to the SCP:
the target NF type, the service name, and the requested S-NSSAI in the corresponding “3gpp-Sbi-Discovery-*” request header(s) (see clause 6.10.3.2 of 3GPP TS 29.500, v17.6.0).

NOTE 2: This is to allow the SCP to discover and reselect a target NF service instance from the target NF instance or target NF (service) set for the corresponding service request and supporting the requested S-NSSAI, e.g., when the NF service producer supports different NF service instances serving different network slices. Likewise, other “3gpp-Sbi-Discovery-*” request header(s), e.g., target-plmn-list, can also be included for the same purpose.

NOTE 3: The inclusion of the 3gpp-Sbi-Discovery-target-nf-instance-id in an HTTP request enables the SCP to discover the profile of the target NF instance and to possibly reselect a different target NF service instance from the same NF instance or from a different NF instance in the same set.

If so, the SCP shall use the information provided by the NF service consumer to perform a NF service discovery procedure and reselect a NF (service) producer instance as specified in the preceding bullets, if possible and if the target NF Service Instance indicated in the “3gpp-Sbi-Target-apiRoot” header or target URI is not reachable.

NOTE 4: This reselection mechanism is applicable only for the request/response service semantics, but not for notify/callback requests.

If the NF instance does not indicate in its NF Profile the support of the capability to persist their resources in shared storage across service instances of the same NF Service, inside the NF Instance, and if it does not indicate in its NF Profile that it belongs to an NF Set or an NF Service Set, the NF Service Consumer or SCP may still reselect any of the exposed service instances, but it shall not assume that the resources created in the former service instance are still valid.

In addition, 3GPP Core Network & Terminal Working Group 4 (CT4) has agreed the following Change Request (CR) to include two alternative solutions for NG-RAN restart, and please refer to “3GPP TSG-CT WG4 Meeting #109-e, E-Meeting, 06th-12th April 2022, C4-222349, ‘Restoration of a Broadcast MBS session upon NG-RAN failure with or without restart’” for details.

However, there are several issues to be addressed with the existing mechanism.

### Issue1:

When performing a Broadcast MBS session start/release/update procedure for a broadcast MBS session as specified in clauses 7.3.1, 7.3.2, and 7.3.3, it is possible that one or a few more NG-RANs as part of MBS Service Area are not reachable, i.e., the Broadcast service will not be available in the area covered by those NG-RAN.

There is lack of mechanism to enable the AMF to report such failure, i.e., one or more NG-RAN is not reachable, to the MB-SMF, therefore it is even not possible to take any remedy action to solve it.

### Issue 2:

As described in the agreed CR C4-222349, for the Broadcast MBS session restoration by AMF, the AMF handling a broadcast MBS session is responsible for restoring the MBS session in a restarted NG-RAN, this AMF will store the last N2 MBS SM container (i.e., MBS Session Information Request Transfer IE defined in 3GPP TS 38.413, v17.0.0) received from the MB-SMF during the establishment of the broadcast MBS session or during a broadcast MBS session update.

It is unclear which AMF pertaining to the same AMF set (as the one handling the MBS session) will be responsible to restore the broadcast MBS session when the AMF which was handling the establishment of the broadcast MBS session or the last update of the broadcast MBS session has failed prior to the NG-RAN failure.

Therefore, some embodiments of the present disclosure propose several mechanisms to deal with possible failure scenarios during start/update/release of a multicast or broadcast MBS Session in 5GS as briefly described as following.

When performing a broadcast MBS session start/release/update procedure for a broadcast MBS session as specified in clauses 7.3.1, 7.3.2, and 7.3.3 in 3GPP TS 23.247, 17.2.0, it is possible that one or a few more NG-RANs as part of MBS Service Area are not reachable by the AMF, i.e., the Broadcast service will not be started or released or updated in the area covered by those NG-RANS.

In some embodiments, the AMF which is receiving the MBS Broadcast Context Create/Update/Release Request message (e.g., Namf_MBSBroadcast_ContextCreate/Namf_MBSBroadcast_ContextUpdate/Namf_MBSBroadcast_ContextRelease Request) from the MB-SMF may report such failure event together with NG-RAN IDs of those NG-RANs (failed to be contacted) to the MB-SMF. The MB-SMF may retransmit the same request (or the same request with a potential, subsequent update, depending on whether there is an update during the restoration procedure), i.e., the MBS Broadcast Context Create/Update/Release Request message, via an alternative AMF pertaining to the same AMF set as the first AMF does towards those NG-RANs identified by the NG-RAN IDs, to avoid potential local link break just between the first AMF and the NG-RANs. The MB-SMF may report such failure to Operations, Administration and Maintenance (OAM).

Please note that the above mechanism can also be used during a Multicast MBS session activation and/or deactivation and/or update procedures as specified in clause 7.2.5 and/or 7.2.6, i.e. when the AMF receives Namf_MBSCommunication_N2MessageTransfer request containing NGAP IE Multicast Session Activation Request Transfer/Multicast Session Deactivation Request Transfer/Multicast Session Update Request Transfer, but failed to contact the NG-RAN, the AMF may report the NG-RAN IDs (failed to be contacted) to the MB-SMF, so that the MB-SMF may try with alternative AMFs.

In some embodiments, once the MB-SMF detects the AMF1 has failed, the MB-SMF may reselect an alternative AMF pertaining to the same AMF set as the AMF1 does, e.g., AMF2, so that the AMF2 becomes the serving AMF for this broadcast MBS session, then the AMF2 is responsible for AMF based restoration to store the N2 Container for MBS session information, to be used for potential NG-RAN restart.

Some embodiments of the present disclosure propose two mechanisms for different failure scenarios during start/update/release/activate/deactivate a multicast or broadcast MBS session.

In some embodiments, the AMF may report failed to be contacted NG-RAN ID to the MB-SMF, so that MB-SMF can at least try to deliver those MBS session signaling message to the failed NG-RAN via an alternative AMF, so to exclude potential failure just between the first AMF and NG-RAN (this is the benefit to deploy AMF set in the network).

In some embodiments, when the MB-SMF detects the AMF1 has failed, the MB-SMF may reselect an alternative AMF pertaining to the same AMF set as the AMF1 does, e.g. AMF2, by sending an MBS session context update request containing the full MBS session information and an indication to indicate the alternative AMF should not further populate the MBS session information to NG-RANs, so that the AMF2 becomes the serving AMF for this broadcast MBS session and has MBS session information be available for AMF based restoration for potential NG-RAN restart.

Without these methods of some embodiments, a broadcast MBS session may be failed to be established/updated/released in one or more NG-RANs just due to local link break between the NG-RANs and the AMF, which is not reasonable when an AMF set is deployed in the network. In other words, with these methods, such a failure can be avoided, for example, when there is only a local link break between the NG-RANs and the AMF.

To support an AMF based restoration procedure for an NG-RAN restart, it is important to have a solution to determine which AMF shall be responsible to store MBS session information (which is included in the N2 Container). The methods of some embodiments enable that the Broadcast MBS session information needs NOT be stored in the shared memory so that the AMFs in the same AMF set can retrieve it; since the MB-SMF will provide a full broadcast MBS session information once it detects the original AMF has failed.

In some embodiments, when the “AMF set” feature is deployed in a network, NG-RANs may be connected with an AMF set. In such a case, the NG-RANs may be able to accept subsequent Broadcast Session Modification or Release Request message sent via an alternative AMF other than the AMF which sent Broadcast Session Setup Request if the alternative AMF pertains to the same AMF set as the old AMF does.

In some embodiments, when the AMF fails to contact one or more NG-RANS when it receives the Namf_MBSBroadcast_ContextCreate or Update or Release Request messages from the MB-SMF, the AMF may report such NG-RAN failure events together with NG-RAN IDs of those NG-RANs (failed to contact) to the MB-SMF. The MB-SMF may reattempt the (same) request via an alternative AMF (pertaining to the same AMF set) towards those NG-RANs identified by the NG-RAN IDs, to avoid potential local link break which is just between the old AMF and the NG-RANs.

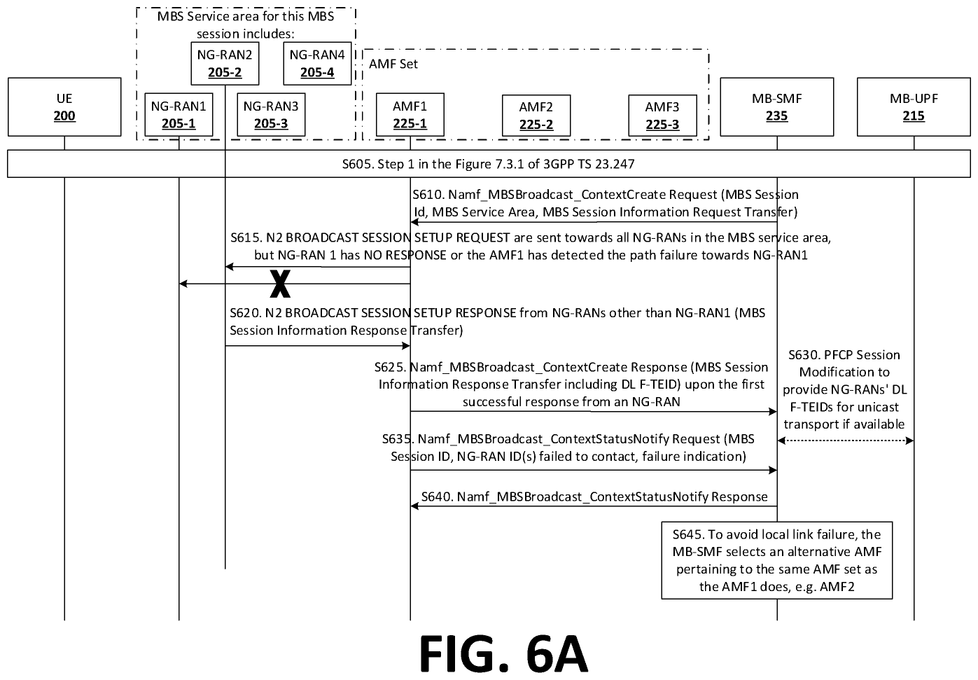

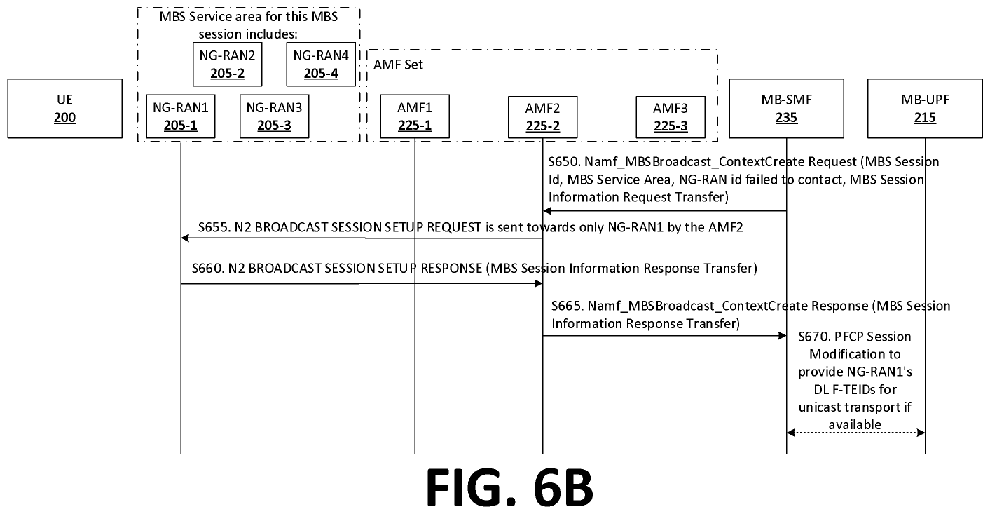

FIG. 6A and FIG. 6B are diagrams illustrating an exemplary procedure for restoring from a failure associated with a multicast or broadcast session via an alternative AMF according to an embodiment of the present disclosure. Please note that, although FIG. 6A and FIG. 6B only show a method where a broadcast MBS session is to be started (or MBS session start for broadcast in subclause 7.3.1 of 3GPP TS 23.247, V17.2.0), the present disclosure is not limited thereto. As mentioned above, this method may also be applicable to other procedures such as, MBS session release for broadcast in subclause 7.3.2 of 3GPP TS 23.247, V17.2.0, MBS session update for broadcast in subclause 7.3.3 of 3GPP TS 23.247, V17.2.0, MBS session activation in subclause 7.2.5.2 of 3GPP TS 23.247, V17.2.0, MBS session deactivation in subclause 7.2.5.3 of 3GPP TS 23.247, V17.2.0, multicast session update in subclause 7.2.6 of 3GPP TS 23.247, V17.2.0, or the like.

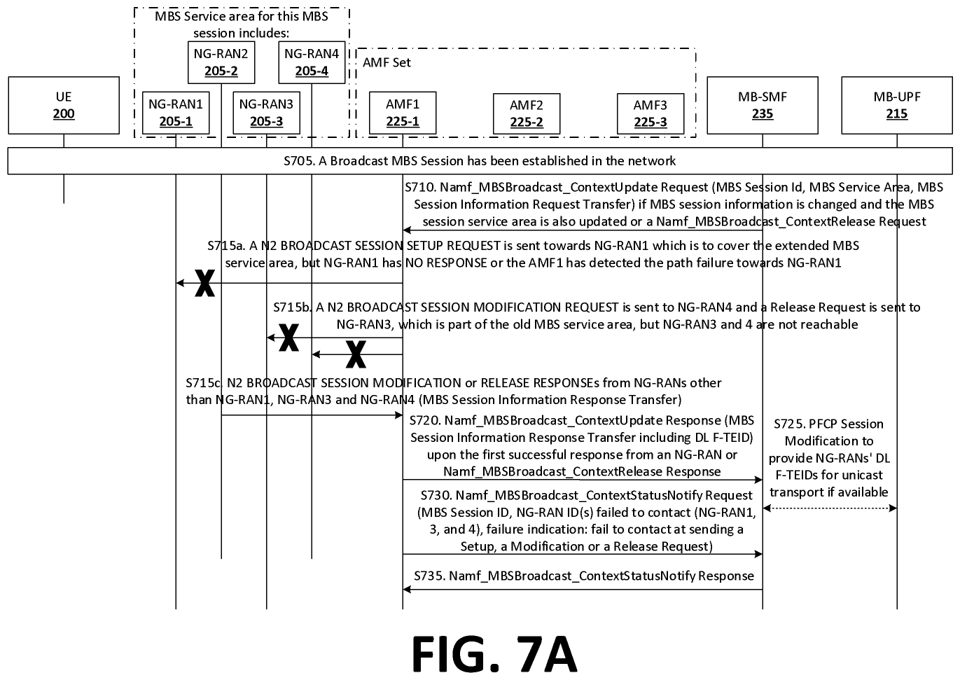

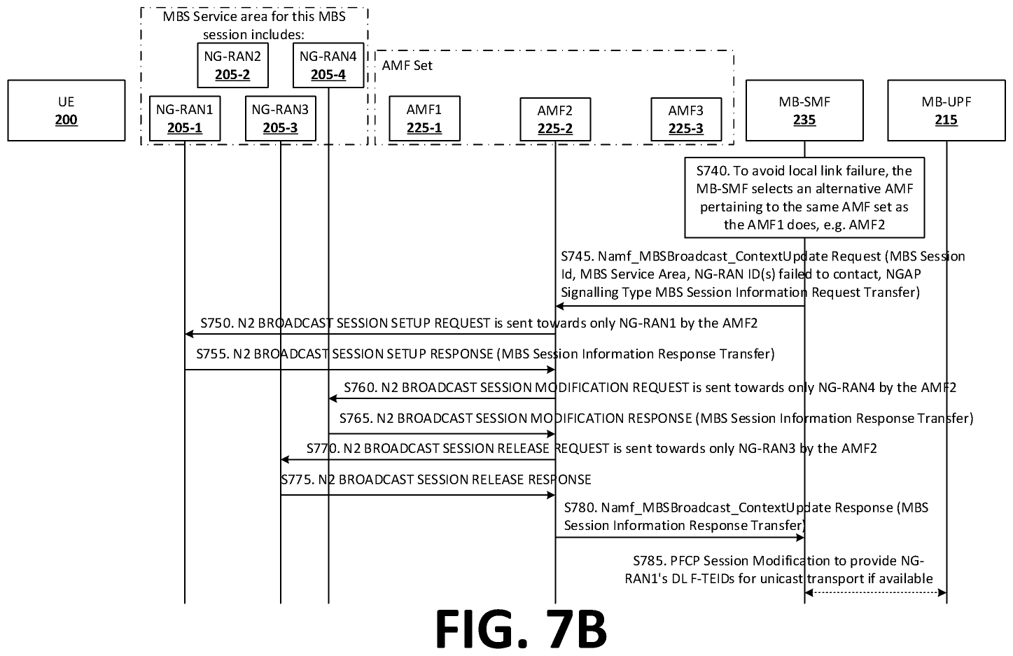

As shown in FIG. 6A, at step S605, a broadcast MBS Session may be requested to be established in the network. In some embodiments, to establish a broadcast MBS session, a TMGI allocation (or generally speaking, MBS session ID allocation) and MBS session creation as specified in clause 7.1.1.2 or 7.1.1.3 of 3GPP TS 23.247, V17.2.0 may be performed in a same manner as step 1 in the FIG. 7.3.1 of 3GPP TS 23.247, V17.2.0. The MBS service type may be broadcast service. The MBS Frequency Selection Area (FSA) ID(s) of a broadcast MBS session may be communicated in the service announcement towards the UE 200. The UE 200 may compare those MBS FSA IDs(s) with the MBS FSA ID(s) in System Information Blocks (SIBs) for frequency selection.

At step S610, the MB-SMF 235 may send an Namf_MBSBroadcast_ContextCreate Request message to the AMF(s) 225-1 which is selected for handling the MBS session. In some embodiments, the request may comprise at least one of the allocated MBS session ID, an MBS service area, and an N2 container “MBS Session Information Request Transfer” that will be passed to the NG-RANs 205. Further, the MB-SMF 235 may include a maximum response time in the request. Furthermore, please note that for other messages transmitted in other procedures (e.g., release/update/activation/deactivation), they may comprise (partially) same and/or (partially) different IEs therein.

At step S615, the AMF 225-1 may use MBS Service Area to retrieve a list of NG-RANs to contact (e.g., the NG-RAN1 205-1 and the NG-RAN2 205-2) and send an N2 BROADCAST SESSION SETUP REQUEST message to each NG-RAN to be contacted (e.g., the NG-RAN1 205-1 and the NG-RAN2 205-2). The message may contain the N2 SM information in the received Namf_MBSBroadcast_ContextCreate Request to all NG-RANs 205 which support MBS in the MBS service area. The AMF 225-1 may include the MBS service area in the request.

As shown in FIG. 6A, some of the NG-RAN 205 (e.g., the NG-RAN1 205-1) do not respond to the request as indicated by the “X”, for example, because either the request is not received by the NG-RAN1 205-1, or the response transmitted by the NG-RAN1 205-1 is not received by the AMF 225-1. As also shown in FIG. 6A, some of the NG-RAN 205 (e.g., the NG-RAN2 205-2) may respond to the request at step S620. For example, the NG-RAN 205-2 may report successful establishment of the MBS Session resources (which may include multiple MBS QoS Flows) by sending an N2 BROADCAST SESSION SETUP RESPONSE message to the AMF 225-1. Further, N3mb DL Tunnel Info may be provided in the response when point-to-point transport applies between the MB-UPF 215 and the NG-RAN 205-2. For more details, refer to TS 38.413, v17.0.0. For another example, the NG-RAN2 205-2 may report failed establishment of the MBS Session resources by sending an N2 BROADCAST SESSION SETUP FAILURE message to the AMF 225-1.

At step S625, the AMF 225-1 may transfer the Namf_MBSBroadcast_ContextCreate Response message to the MB-SMF 235. The AMF 225-1 may respond success when it receives the first success response from the NG-RAN(s). If none of NG-RAN is reachable, the AMF 225-1 may respond failure of the Namf_MBSBroadcast_ContextCreate Request and in this case, the MB-SMF 235 may select an alternative AMF in the same AMF set and perform step S650 without including a list of NG-RAN ID(s). If all NG-RAN(s) report failure or all reachable NG-RAN(s) report failure, the AMF 225-1 may respond failure as well. The MB-SMF 235 may store the AMF(s) which responds success in the MBS Session Context as the downstream nodes. If the AMF 225-1 receives the NG-RAN response(s) from all involved NG-RAN(s) 205, the AMF may include an indication of completion of the operation in all NG-RANS 205.

At step S630, the MB-SMF 235 may trigger PFCP Session Modification Request messages to the MB-UPF 215 if needed to update NG-RAN(s)'s DL Fully Qualified TEID(s) (F-TEID(s)) for the MBS Session if unicast transport is used for N3mb interface. In other words, if N3mb point-to-point transport is to be used (i.e., N3mb DL Tunnel Info is present in the Namf_MBSBroadcast_ContextCreate Response message from AMF 225-1), the MB-SMF 235 may send an N4mb Session Modification Request to the MB-UPF 215 to allocate the N3mb point-to-point transport tunnel for a replicated MBS stream for the MBS Session. Otherwise, step S630 can be skipped.

Further, for those NG-RANs that the AMF1 225-1 failed to contact (e.g., the NG-RAN1 205-1), the AMF1 225-1 may send, at step S635, one or more

Namf_MBSBroadcast_ContextStatusNotify Request messages to the MB-SMF 235 to inform the MB-SMF 235 of the NG-RANs that the AMF 225-1 failed to contact for the MBS session. In some embodiments, the request message may comprise at least one of: the MBS session ID, the IDs of NG-RANs (e.g., an ID of the NG-RAN1 205-1) that the AMF 225-1 failed to contact, and an indication indicating this failure. In some other embodiments, the indication may indicate other failure reasons than the contact failure. In response to this notify request message, the MB-SMF 235 may respond, at step S640, with an Namf_MBSBroadcast_ContextStatusNotify Response message acknowledging the safe receipt of the request message.

Further, upon receipt of the notify message at step S635, the MB-SMF 235 may select, at step S645, an alternative AMF (e.g., the AMF2 225-2) pertaining to the same AMF set as the AMF1 225-1 does to avoid a local link failure between the AMF1 225-1 and the NG-RAN1 205-1. For example, the MB-SMF 235 may select the AMF 225-2 pertaining to the same AMF set using the Binding Indication provided by the old AMF 225-1 or using the NF profile of the old AMF 225-1.

Referring to FIG. 6B, at step S650, the MB-SMF 235 may retransmit the same request, i.e., the Namf_MBSBroadcast_ContextCreate Request (or

Namf_MBSBroadcast_ContextUpdate Request/Namf_MBSBroadcast_ContextRelease Request) message (or the same request with a potential, subsequent update depending on whether there is an update during the restoration procedure, for example, during a time period between step S615 and step S650), via the alternative AMF2 225-2 towards the NG-RAN1 205-1 identified by the NG-RAN ID in the notify message, to exclude potential local link break just between the first AMF1 225-1 and the NG-RAN1 205-1. For example, the MB-SMF 235 may send an Namf_MBSBroadcast_ContextCreate Request including an MBS Session ID, the corresponding MBS Service Area, an MBS Session Information Request Transfer, and a list of NG-RAN ID(s) to contact.

Upon receipt of the request message comprising specific NG-RAN ID(s) (e.g., the ID of the NG-RAN1 205-1), the AMF2 225-2 may know that only the NG-RAN1 205-1 shall be contacted for the intended operation (e.g., MBS session create/release/update/activation/deactivation) even if a service area may also be indicated by the request message, and therefore at step S655 the AMF2 225-2 may transmit an N2 BROADCAST SESSION SETUP REQUEST to the NG-RAN1 205-1 (or each NG-RAN as identified by the NG-RAN ID(s)). This message per se may be substantially similar to that sent at step S615, and therefore the description thereof is omitted for simplicity.

Further, the steps S660, S665, and S670 are substantially similar to steps S620, S625, and S630, respectively, and therefore the description thereof is omitted for simplicity.

With the method shown in FIG. 6A and FIG. 6B, a failure of an MBS related procedure can be avoided when there is only a local link break between the NG-RAN1 205-1 and the AMF1 225-1.

FIG. 7A and FIG. 7B are diagrams illustrating another exemplary procedure for restoring from a failure associated with a multicast or broadcast session via an alternative AMF according to another embodiment of the present disclosure. To be specific, FIG. 7A and FIG. 7B show an exemplary procedure for restoring from a failure during delivery of Namf_MBSBroadcast_ContextUpdate or Release Request messages.

At step S705, a Broadcast MBS Session has been established in the network.

At step S710, the MB-SMF 235 may send an Namf_MBSBroadcast_ContextUpdate Request that may include at least one of an MBS Session ID, a corresponding MBS Service Area, and an MBS Session Information Request Transfer or send an Namf_MBSBroadcast_ContextRelease Request message with the MBS session reference id to the AMF 225-1 which is handling the MBS session.

At steps S715a/S715b/S715c, when receiving an Namf_MBSBroadcast_ContextUpdate Request from the MB-SMF 235, the AMF 225-1 may use MBS Service Area to retrieve a list of NG-RANs to contact and send at least one of:
an N2 Broadcast Session Modification Request to each NG-RAN which is covering the old MBS Service Area (e.g., to the NG-RAN4 205-4 at step S715b);
an N2 Broadcast Session Setup Request to each NG-RAN which is to cover the extended MBS Service Area (e.g., to the NG-RAN1 205-1 at step S715a);
an N2 Broadcast Session Release Request to each NG-RAN which is covering the MBS Service Area being reduced (e.g., to the NG-RAN3 205-3 at step S715b).

Further, when receiving an Namf_MBSBroadcast_ContextRelease Request message, the AMF 225-1 may send an N2 Broadcast Session Release Request to all NG-RANs for the MBS session.

In some embodiments, the AMF 225-1 may detect some NG-RANs are not reachable for setup, modification and/or release requests, e.g. NG-RAN1 205-1, NG-RAN3 205-3, and NG-RAN4 205-4 as shown by FIG. 7A. In other words, if the AMF 225-1 failed to contact some of NG-RANs, it needs to report to MB-SMF 235 an NgranFailureEvent as defined in the APPENDIX C as will be done at step S730.

Further, some of NG-RANS (e.g., the NG-RAN2 205-2) may respond success to modification or release of the MBS session.

In some embodiments, the AMF 225-1 may respond, at step S720, success to the MB-SMF 235 at receiving the first successful response from the NG-RAN(s). If none of NG-RANs is reachable or none of reachable NG-RANs responds success, the AMF 225-1 may respond failure of the Namf_MBSBroadcast_ContextUpdate or Release Request. In this case and/or in a case where at least one NG-RAN is not reachable, the MB-SMF 235 may then, e.g., at step S740, select an alternative AMF (e.g., the AMF 225-2) in the same AMF set and perform step S745 without including a list of NG-RAN ID(s).

At step S725, the MB-SMF 235 may trigger PFCP Session Modification Request messages to the MB-UPF 215 if needed to update NG-RAN(s)'s DL F-TEID(s) for the MBS Session if unicast transport is used for N3mb interface.

At step S730, the AMF 225-1 may send one or more Namf_MBSBroadcast_ContextStatusNotify request to report NG-RAN failure events as mentioned above.

At step S735, the MB-SMF 235 may respond to Namf_MBSBroadcast_ContextStatusNotify requests.

At step S740, the MB-SMF 235 may select an alternative AMF (e.g., the AMF 225-2) pertaining to the same AMF set using the Binding Indication provided by the old AMF 225-1 or using the NF profile of the old AMF 225-1, as mentioned earlier.

At step S745, the MB-SMF 235 may send an Namf_MBSBroadcast_ContextUpdate Request including at least one of an MBS Session ID, the corresponding MBS Service Area, an MBS Session Information Request Transfer, and a list of ngranForUpdate including NG-RAN ID(s) to contact and the corresponding NGAP signalling type.

When the MB-SMF 235 sends Namf_MBSBroadcast_ContextRelease request in the step S710, i.e. the MBS session is to be released, the MB-SMF 235 may set the “relMbsSessionInd” attribute to “true” in the Namf_MBSBroadcast_ContextUpdate Request message to request the alternative AMF 225-2 to release the MBS session in the NG-RANs and also in the AMF 225-2.

At steps S750 through S775, the AMF 225-2 may send an N2 Broadcast Session Setup or Modification or Release Request to each NG-RAN as identified by the NG-RAN ID(s) and according to the NGAP signalling type.

At step S780, the AMF 225-2 may respond success to the MB-SMF 235.

At step S785, the MB-SMF 235 may trigger PFCP Session Modification Request messages if needed to the MB-UPF 215 to update NG-RAN(s)'s DL F-TEID(s) for the MBS Session if unicast transport is used for N3mb interface.

With the method shown in FIG. 7A and FIG. 7B, a failure of an MBS related procedure can be avoided when there is only local link breaks between the NG-RAN1/3/4 205-1/205-3/205-4 and the AMF1 225-1.

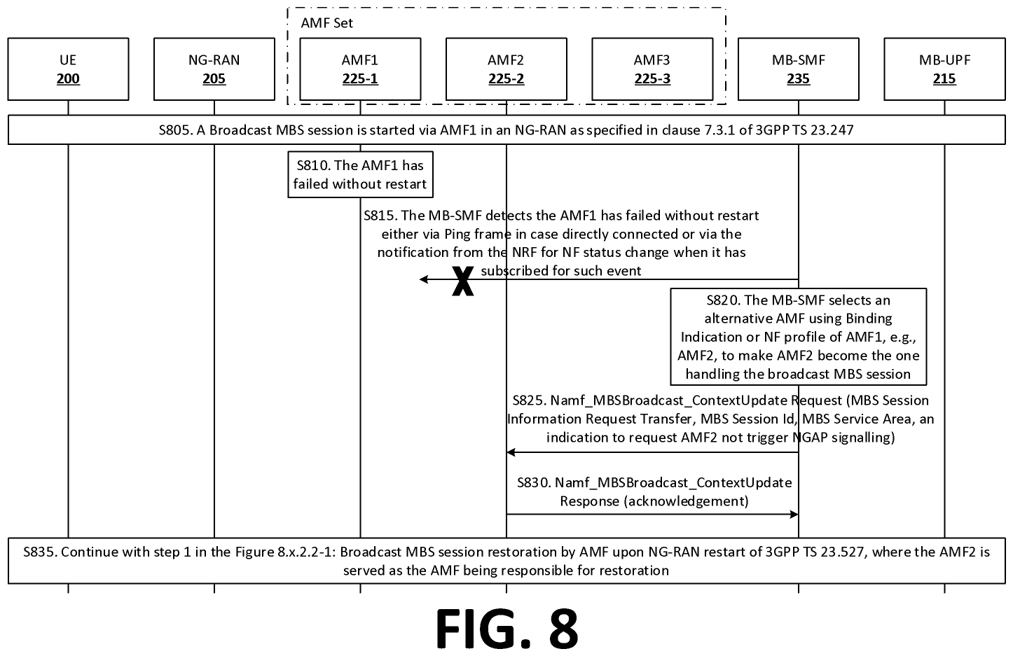

In some embodiments, when an MB-SMF detects an AMF which was handling a Broadcast MBS session has failed, the MB-SMF may reselect an alternative AMF by sending an Namf_MBSBroadcast_ContextUpdate Request message with an indication to require the alternative AMF to not trigger any NGAP message to deliver N2 container-MBS Session Information Request Transfer, but just to store it for future potential NG-RAN restoration as described in clause 8.x.2.2 of APPENDIX B, so that this alternative AMF becomes the serving AMF for this broadcast MBS session and is responsible for restoration. This procedure will be described below with reference to FIG. 8.

FIG. 8 is a diagram illustrating another exemplary procedure for restoring from a failure associated with a broadcast session via an alternative AMF according to another embodiment of the present disclosure.

As shown in FIG. 8, a broadcast MBS session may be started at step S805, and MBS session data may be sent to the UE 200 via the NG-RAN 205.

At step S810, the AMF1 225-1 may fail without restart or otherwise stop responding to any communication related to the MBS session. At step S815, the MB-SMF 235 may detect the AMF1 225-1 has failed (or at least has stopped responding to any communication related to the MBS session), for example via HTTP/2 Ping Frame when it is directly connected to the AMF1 225-1, or via the notification from an NRF for NF status change of the AMF1 225-1 when the MB-SMF 235 has subscribed for such an event. No matter how the MB-SMF 235 detects the failure of the AMF1 225-1, the MB-SMF 235 may reselect an alternative AMF2 225-2 for subsequent operations related to the MBS session at step S820. In other words, the MB-SMF 235 may select the AMF2 225-2 to handle the broadcast MBS session.

At S825, the MB-SMF 235 may send an Namf_MBSBroadcast_ContextUpdate Request message with a restoration indication to enable the AMF2 225-2 to know that it should not trigger any NGAP message to deliver N2 container-MBS Session Information Request Transfer, but just to store it for future potential NG-RAN restoration. This is at least partially because there is no need for the NG-RAN 205 to be aware of the change of its serving AMF when the NG-RAN 205 does not care about which AMF is serving for the MBS session. In such a case, the AMF2 225-2 may become the serving AMF for this broadcast MBS session and is responsible for subsequent restoration if any.

At step S830, the AMF2 225-2 may respond to the request by sending an Namf_MBSBroadcast_ContextUpdate Response message.

At step S835, if there is any failure associated with the MBS session, for example, NG-RAN 205 restart, the AMF2 225-2, instead of the AMF1 225-1, may handle the restoration of the MBS session as defined in 3GPP TS 23.527, V17.3.1.

With the method shown in FIG. 8, the broadcast MBS session information needs not be stored in the shared memory of the AMF set, so that the AMFs in the same AMF set can retrieve it from the MB-SMF directly; since the MB-SMF will provide a full broadcast MBS session information once it detects the original AMF has failed.

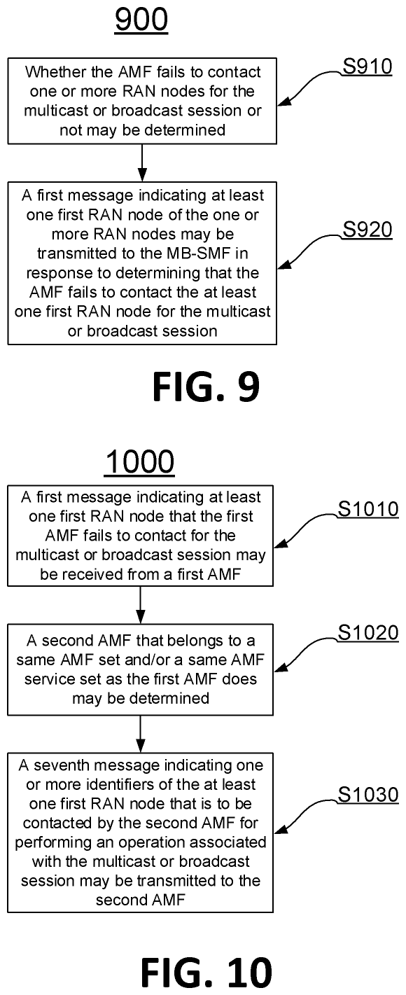

FIG. 9 is a flow chart of an exemplary method 900 at an AMF for facilitating an MB-SMF in attempting a multicast session signaling for a multicast session or a broadcast session signaling for a broadcast session according to an embodiment of the present disclosure. The method 900 may be performed at a first network node (e.g., the AMF 225 shown in FIG. 2). The method 900 may comprise steps S910 and S920. However, the present disclosure is not limited thereto. In some other embodiments, the method 900 may comprise more steps, less steps, different steps, or any combination thereof. Further the steps of the method 900 may be performed in a different order than that described herein. Further, in some embodiments, a step in the method 900 may be split into multiple sub-steps and performed by different entities, and/or multiple steps in the method 900 may be combined into a single step.

The method 900 may begin at step S910 where whether the AMF fails to contact one or more RAN nodes for the multicast or broadcast session or not may be determined.

At step S920, a first message indicating at least one first RAN node of the one or more RAN nodes may be transmitted to the MB-SMF in response to determining that the AMF fails to contact the at least one first RAN node for the multicast or broadcast session.

In some embodiments, before the step of determining whether the AMF fails to contact one or more RAN nodes for the multicast or broadcast session or not, the method 900 may further comprise: transmitting, to each of the one or more RAN nodes, a second message associated with the multicast or broadcast session, wherein the step of determining that the AMF fails to contact the at least one first RAN node may comprise: determining that the at least one first RAN node does not respond to the second message within a period of time. In some embodiments, the step of determining that the AMF fails to contact the at least one first RAN node may comprise: determining that there is a failure in a path towards the at least one first RAN node.

In some embodiments, the first message may indicate at least one of: at least one identifier of the at least one first RAN node; an identifier of the multicast or broadcast session; and an indication indicating a failure in contacting the at least one first RAN node. In some embodiments, the indication may further indicate at least one of: whether the AMF has detected a (re) start of a corresponding NG-RAN or not; whether the AMF has detected a failure without a restart of a corresponding NG-RAN or not; whether the AMF has failed to reach a corresponding NG-RAN when sending an NGAP MBS Session Setup Request message or not; whether the AMF has failed to reach a corresponding NG-RAN when sending an NGAP MBS Session Modification Request message or not; and whether the AMF has failed to reach a corresponding NG-RAN when sending an NGAP MBS Session Release Request message or not. In some embodiments, the method 900 may further comprise: receiving, from the MB-SMF, a third message acknowledging the first message. In some embodiments, before the step of determining whether the AMF fails to contact one or more RAN nodes for the multicast or broadcast session or not, the method 900 may further comprise: receiving, from the MB-SMF, a fourth message indicating that the AMF is to contact the one or more RAN nodes for performing an operation associated with the multicast or broadcast session. In some embodiments, the fourth message may indicate at least one of: an identifier of the multicast or broadcast session; a service area associated with the multicast or broadcast session; and information associated with the multicast or broadcast session that is to be passed to the one or more RAN nodes. In some embodiments, the second message may be transmitted in response to the reception of the fourth message.

In some embodiments, the method 900 may further comprise: receiving, from each of at least one second RAN node of the one or more RAN nodes, a fifth message indicating whether an operation associated with the multicast or broadcast session is successfully performed or not in response to the second message being transmitted; and transmitting, to the MB-SMF, a sixth message indicating whether the operation is successfully performed or not at least based on the fifth message. In some embodiments, the method 900 may further comprise: receiving, from the MB-SMF, a seventh message indicating one or more identifiers of one or more third RAN nodes that are to be contacted by the AMF for performing an operation associated with another multicast or broadcast session; transmitting, to each of the one or more third RAN nodes, an eighth message indicating the one or more third RAN nodes to perform the operation associated with the other multicast or broadcast session at least based on the seventh message; receiving, from at least one of the one or more third RAN nodes, at least one ninth message indicating whether the operation associated with the other multicast or broadcast session is successfully performed or not by the at least one corresponding third RAN node in response to the eighth message being transmitted; and transmitting, to the MB-SMF, a tenth message indicating whether the operation associated with the other multicast or broadcast session is successfully performed or not at least based on the ninth message. In some embodiments, the seventh message may indicate at least one signalling type associated with at least one of the one or more third RAN nodes, respectively. In some embodiments, the eighth message may be a request message having the type indicated by the seventh message, and/or the corresponding ninth message may be a response or failure message having the type indicated by the seventh message. In some embodiments, the seventh message may further indicate whether or not the multicast or broadcast session is to be released at the AMF and/or the one or more third RAN nodes.

In some embodiments, at least one of the fifth message, the sixth message, the ninth message, and the tenth message may further indicate unicast TNL information for shared delivery of the multicast or broadcast session. In some embodiments, the multicast or broadcast session may be an MBS session. In some embodiments, when the multicast or broadcast session is a broadcast MBS session, at least one of following may be true: the first message is an Namf_MBSBroadcast_ContextStatusNotify Request message; the second message is one of a Broadcast Session Setup Request message, a Broadcast Session Release Request message, and a Broadcast Session Modification Request message; the third message is an Namf_MBSBroadcast_ContextStatusNotify Response message; the fourth message is one of an

Namf_MBSBroadcast_ContextCreate Request message, an Namf_MBSBroadcast_ContextRelease Request message, an Namf_MBSBroadcast_ContextUpdate Request message; the fifth message is one of a Broadcast Session Setup Response message, a Broadcast Session Release Response message, and a Broadcast Session Modification Response message; the sixth message is one of an Namf_MBSBroadcast_ContextCreate Response message, an Namf_MBSBroadcast_ContextRelease Response message, an Namf_MBSBroadcast_ContextUpdate Response message; the seventh message is one of an Namf_MBSBroadcast_ContextCreate Request message, an Namf_MBSBroadcast_ContextRelease Request message, an

Namf_MBSBroadcast_ContextUpdate Request message; the eighth message is one of a Broadcast Session Setup Request message, a Broadcast Session Release Request message, and a Broadcast Session Modification Request message; the ninth message is one of a Broadcast Session Setup Response message, a Broadcast Session Release Response message, and a Broadcast Session Modification Response message; and the tenth message is one of an Namf_MBSBroadcast_ContextCreate Response message, an Namf_MBSBroadcast_ContextRelease Response message, an Namf_MBSBroadcast_ContextUpdate Response message.

FIG. 10 is a flow chart of an exemplary method 1000 at an MB-SMF for attempting a multicast session signaling for a multicast session or a broadcast session signaling for a broadcast session according to an embodiment of the present disclosure. The method 1000 may be performed at a second network node (e.g., the MB-SMF 235 shown in FIG. 2). The method 1000 may comprise steps S1010, S1020, and S1030. However, the present disclosure is not limited thereto. In some other embodiments, the method 1000 may comprise more steps, less steps, different steps, or any combination thereof. Further the steps of the method 1000 may be performed in a different order than that described herein. Further, in some embodiments, a step in the method 1000 may be split into multiple sub-steps and performed by different entities, and/or multiple steps in the method 1000 may be combined into a single step.

The method 1000 may begin at step S1010 where a first message indicating at least one first RAN node that the first AMF fails to contact for the multicast or broadcast session may be received from a first AMF.

At step S1020, a second AMF that belongs to a same AMF set and/or a same AMF service set as the first AMF does may be determined.

At step S1030, a seventh message indicating one or more identifiers of the at least one first RAN node that is to be contacted by the second AMF for performing an operation associated with the multicast or broadcast session may be transmitted to the second AMF.

In some embodiments, the first message may indicate at least one of: at least one identifier of the at least one first RAN node; an identifier of the multicast or broadcast session; and an indication indicating a failure at the first AMF in contacting the at least one first RAN node. In some embodiments, the indication may further indicate at least one of: whether the first AMF has detected a (re) start of a corresponding NG-RAN or not; whether the first AMF has detected a failure without a restart of a corresponding NG-RAN or not; whether the first AMF has failed to reach a corresponding NG-RAN when sending an NGAP MBS Session Setup Request message or not; whether the first AMF has failed to reach a corresponding NG-RAN when sending an NGAP MBS Session Modification Request message or not; and whether the first AMF has failed to reach a corresponding NG-RAN when sending an NGAP MBS Session Release Request message or not. In some embodiments, the seventh message may be generated at least based on the received indication, such that the seventh message indicates at least one signalling type associated with the at least one first RAN nodes, respectively. In some embodiments, the seventh message may further indicate whether or not the multicast or broadcast session is to be released at the second AMF and/or the at least one first RAN node.

In some embodiments, the method 1000 may further comprise: transmitting, to the first AMF, a third message acknowledging the first message. In some embodiments, before the step of receiving the first message, the method 1000 may further comprise: transmitting, to the first AMF, a fourth message indicating that the first AMF is to contact one or more RAN nodes, which may comprise the at least one first RAN node, for performing the operation associated with the multicast or broadcast session. In some embodiments, the fourth message may indicate at least one of: an identifier of the multicast or broadcast session; a service area associated with the multicast or broadcast session; and information associated with the multicast or broadcast session that is to be passed to the one or more RAN nodes.

In some embodiments, the method 1000 may further comprise: receiving, from the first AMF, a sixth message indicating whether an operation associated with the multicast or broadcast session is successfully performed by the one or more RAN nodes or not. In some embodiments, the method 1000 may further comprise: receiving, from the second AMF, a tenth message indicating whether the operation associated with the multicast or broadcast session is successfully performed by the at least one RAN node or not. In some embodiments, at least one of the sixth message and the tenth message may further indicate unicast TNL information for shared delivery of the multicast or broadcast session. In some embodiments, the method 1000 may further comprise: communicating, with an MB-UPF, for providing the unicast TNL information for shared delivery of the multicast or broadcast session from the MB-UPF to the one or more RAN nodes or the at least one first RAN node.

In some embodiments, the multicast or broadcast session may be an MBS session. In some embodiments, when the multicast or broadcast session is a broadcast MBS session, at least one of following may be true: the first message is an Namf_MBSBroadcast_ContextStatusNotify Request message; the third message is an Namf_MBSBroadcast_ContextStatusNotify Response message; the fourth message is one of an Namf_MBSBroadcast_ContextCreate Request message, an Namf_MBSBroadcast_ContextRelease Request message, an

Namf_MBSBroadcast_ContextUpdate Request message; the sixth message is one of an Namf_MBSBroadcast_ContextCreate Response message, an Namf_MBSBroadcast_ContextRelease Response message, an Namf_MBSBroadcast_ContextUpdate Response message; the seventh message is one of an Namf_MBSBroadcast_ContextCreate Request message, an Namf_MBSBroadcast_ContextRelease Request message, an Namf_MBSBroadcast_ContextUpdate Request message; and the tenth message is one of an Namf_MBSBroadcast_ContextCreate Response message, an Namf_MBSBroadcast_ContextRelease Response message, an Namf_MBSBroadcast_ContextUpdate Response message.

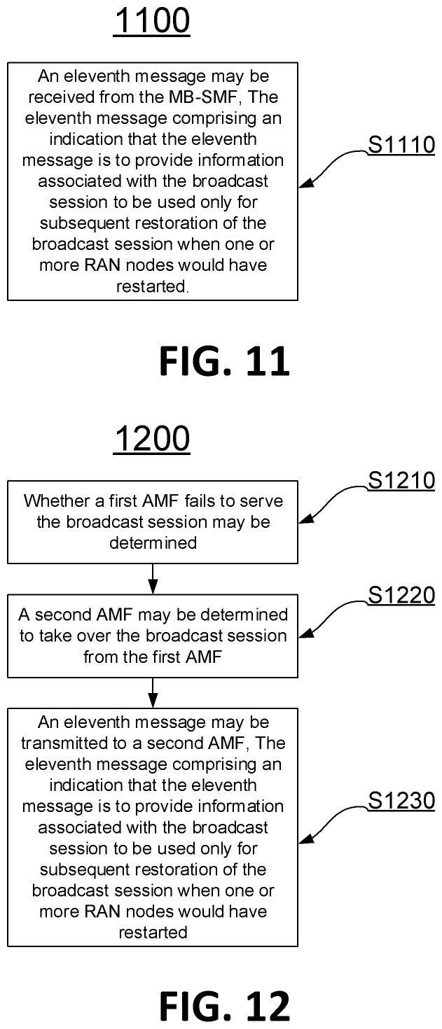

FIG. 11 is a flow chart of an exemplary method 1100 at an AMF for facilitating an MB-SMF in restoring a broadcast session according to an embodiment of the present disclosure. The method 1100 may be performed at a first network node (e.g., the AMF 225 shown in FIG. 2). The method 1100 may comprise a step S1110. However, the present disclosure is not limited thereto. In some other embodiments, the method 1100 may comprise more steps, different steps, or any combination thereof. Further the steps of the method 1100 may be performed in a different order than that described herein. Further, in some embodiments, a step in the method 1100 may be split into multiple sub-steps and performed by different entities, and/or multiple steps in the method 1100 may be combined into a single step.

The method 1100 may begin at step S1110 where an eleventh message may be received from the MB-SMF, the eleventh message comprising an indication that the eleventh message is to provide information associated with the broadcast session to be used only for subsequent restoration of the broadcast session when one or more RAN nodes would have restarted.

In some embodiments, the eleventh message may indicate at least one of: an identifier of the broadcast session; a service area associated with the broadcast session; information required for subsequent restorations of the broadcast session; and a restoration indication indicating that the AMF is not to trigger any NGAP signaling to the one or more RAN nodes for restoring the broadcast session. In some embodiments, when the restoration indication is set to “true” and the service area is indicated by the eleventh message, the AMF may be requested to not trigger any NGAP signaling towards one or more NG-RAN nodes covering the indicated service area. In some embodiments, the AMF and another AMF, which was used for restoration of the broadcast session, may belong to a same AMF set and/or a same AMF service set. In some embodiments, the method 1100 may further comprise: transmitting, to the MB-SMF, a twelfth message acknowledging the eleventh message and indicating that the AMF has taken over the broadcast session from the other AMF. In some embodiments, the broadcast session may be an MBS session. In some embodiments, at least one of following may be true: the eleventh message is an Namf_MBSBroadcast_ContextUpdate Request message; and the twelfth message is an Namf_MBSBroadcast_ContextUpdate Response message.

FIG. 12 is a flow chart of an exemplary method 1200 at an MB-SMF for restoring a broadcast session according to an embodiment of the present disclosure. The method 1200 may be performed at a second network node (e.g., the MB-SMF 235 shown in FIG. 2). The method 1200 may comprise steps S1210, S1220, and S1230. However, the present disclosure is not limited thereto. In some other embodiments, the method 1200 may comprise more steps, less steps, different steps, or any combination thereof. Further the steps of the method 1200 may be performed in a different order than that described herein. Further, in some embodiments, a step in the method 1200 may be split into multiple sub-steps and performed by different entities, and/or multiple steps in the method 1200 may be combined into a single step.

The method 1200 may begin at step S1210 where whether a first AMF fails to serve the broadcast session may be determined.

At step S1220, a second AMF may be determined to take over the broadcast session from the first AMF.

At step S1230, an eleventh message may be transmitted to a second AMF, the eleventh message comprising an indication that the eleventh message is to provide information associated with the broadcast session to be used only for subsequent restoration of the broadcast session when one or more RAN nodes would have restarted.

In some embodiments, the eleventh message may indicate at least one of: an identifier of the broadcast session; a service area associated with the broadcast session; information required by the second AMF for subsequent restorations of the broadcast session; and a restoration indication indicating that the second AMF is not to trigger any NGAP signaling to the one or more RAN nodes for restoring the broadcast session. In some embodiments, when the restoration indication is set to “true” and the service area is indicated by the eleventh message, the second AMF may be requested to not trigger any NGAP signaling towards one or more NG-RAN nodes covering the indicated service area. In some embodiments, the first AMF and the second AMF may belong to a same AMF set and/or a same AMF service set. In some embodiments, the method 1200 may further comprise: receiving, from the second AMF, a twelfth message acknowledging the eleventh message and indicating that the second AMF has taken over the broadcast session from the first AMF. In some embodiments, the step of determining whether a first AMF fails to serve the broadcast session may comprise: detecting whether the first AMF fails to serve the broadcast session by using an HTTP/2 Ping Frame.

In some embodiments, before the step of determining whether a first AMF fails to serve the broadcast session, the method 1200 may further comprise: subscribing, to an NRF, to receive a notification of a change of a profile of the first AMF, wherein the step of determining whether a first AMF fails to serve the broadcast session may comprise: receiving, from the NRF, a notification of a change of the profile of the first AMF, which may indicate that the first AMF fails to serve the broadcast session. In some embodiments, the broadcast session may be an MBS session. In some embodiments, at least one of following may be true: the eleventh message is an Namf_MBSBroadcast_ContextUpdate Request message; and the twelfth message is an Namf_MBSBroadcast_ContextUpdate Response message.

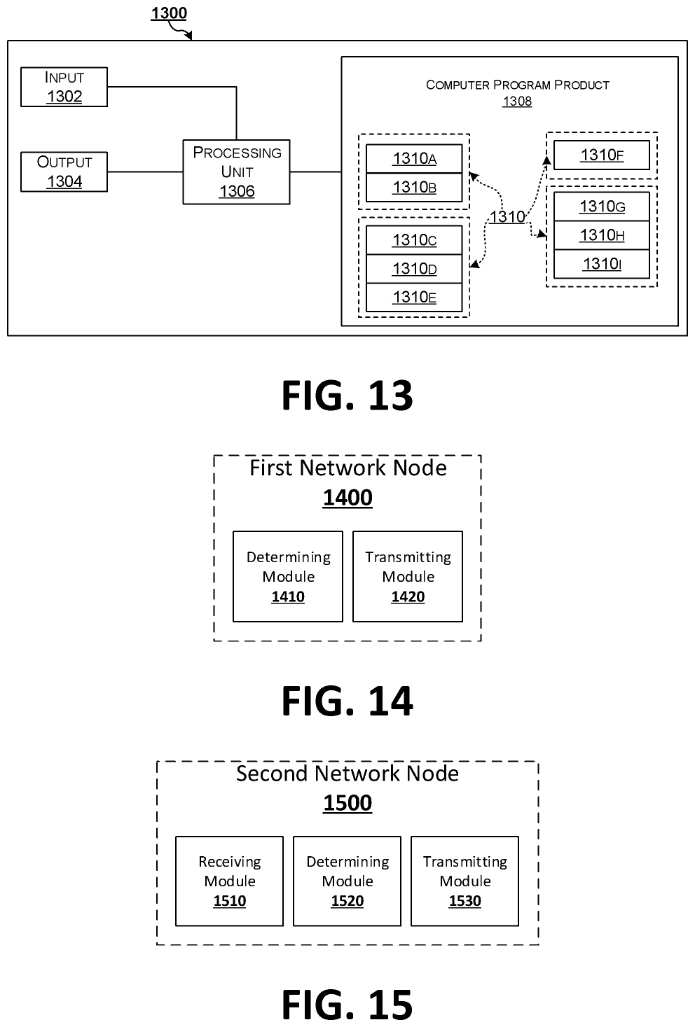

FIG. 13 schematically shows an embodiment of an arrangement which may be used in a network node according to an embodiment of the present disclosure. Comprised in the arrangement 1300 are a processing unit 1306, e.g., with a Digital Signal Processor (DSP) or a Central Processing Unit (CPU). The processing unit 1306 may be a single unit or a plurality of units to perform different actions of procedures described herein. The arrangement 1300 may also comprise an input unit 1302 for receiving signals from other entities, and an output unit 1304 for providing signal(s) to other entities. The input unit 1302 and the output unit 1304 may be arranged as an integrated entity or as separate entities.

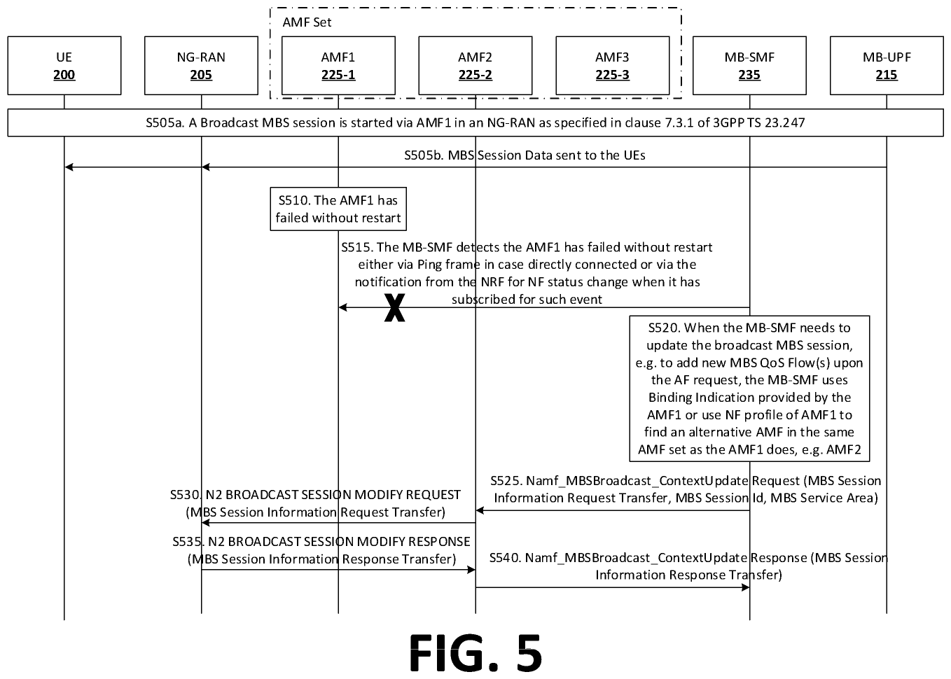

Furthermore, the arrangement 1300 may comprise at least one computer program product 1308 in the form of a non-volatile or volatile memory, e.g., an Electrically Erasable Programmable Read-Only Memory (EEPROM), a flash memory and/or a hard drive. The computer program product 1308 comprises a computer program 1310, which comprises code/computer readable instructions, which when executed by the processing unit 1306 in the arrangement 1300 causes the arrangement 1300 and/or the network nodes in which it is comprised to perform the actions, e.g., of the procedure described earlier in conjunction with FIG. 5 through FIG. 12 or any other variant.

The computer program 1310 may be configured as a computer program code structured in computer program modules 1310A and 1310B. Hence, in an exemplifying embodiment when the arrangement 1300 is used in a first network node, the code in the computer program of the arrangement 1300 includes: a module 1310A configured to determine whether an AMF fails to contact one or more RAN nodes for the multicast or broadcast session or not; and a module 1310B configured to transmit, to the MB-SMF, a first message indicating at least one first RAN node of the one or more RAN nodes in response to determining that the AMF fails to contact the at least one first RAN node for the multicast or broadcast session.

Alternatively or additionally, the computer program 1310 may be configured as a computer program code structured in computer program modules 1310C, 1310D, and 1310E. Hence, in an exemplifying embodiment when the arrangement 1300 is used in a second network node, the code in the computer program of the arrangement 1300 includes: a module 1310C configured to receive, from a first AMF, a first message indicating at least one first RAN node that the first AMF fails to contact for the multicast or broadcast session; a module 1310D configured to determine a second AMF that belongs to a same AMF set and/or a same AMF service set as the first AMF does; and a module 1310E configured to transmit, to the second AMF, a seventh message indicating one or more identifiers of the at least one first RAN node that is to be contacted by the second AMF for performing an operation associated with the multicast or broadcast session.

Alternatively or additionally, the computer program 1310 may be configured as a computer program code structured in a computer program module 1310F. Hence, in an exemplifying embodiment when the arrangement 1300 is used in a first network node, the code in the computer program of the arrangement 1300 includes: a module 1310F configured to receive, from the MB-SMF, an eleventh message comprising an indication that the eleventh message is to provide information associated with the broadcast session to be used only for subsequent restoration of the broadcast session when one or more RAN nodes would have restarted

Alternatively or additionally, the computer program 1310 may be configured as a computer program code structured in computer program modules 1310G, 1310H, and 1310I. Hence, in an exemplifying embodiment when the arrangement 1300 is used in a second network node, the code in the computer program of the arrangement 1300 includes: a module 1310G configured to determine whether a first AMF fails to serve the broadcast session; a module 1310H configured to determine a second AMF to take over the broadcast session from the first AMF; and a module 1310I configured to transmit, to a second AMF, an eleventh message comprising an indication that the eleventh message is to provide information associated with the broadcast session to be used only for subsequent restoration of the broadcast session when one or more RAN nodes would have restarted.

The computer program modules could essentially perform the actions of the flow illustrated in FIG. 5 through FIG. 12, to emulate the network nodes. In other words, when the different computer program modules are executed in the processing unit 1306, they may correspond to different modules in the network nodes.

Although the code means in the embodiments disclosed above in conjunction with FIG. 13 are implemented as computer program modules which when executed in the processing unit causes the arrangement to perform the actions described above in conjunction with the figures mentioned above, at least one of the code means may in alternative embodiments be implemented at least partly as hardware circuits.

The processor may be a single CPU (Central processing unit), but could also comprise two or more processing units. For example, the processor may include general purpose microprocessors; instruction set processors and/or related chips sets and/or special purpose microprocessors such as Application Specific Integrated Circuit (ASICs). The processor may also comprise board memory for caching purposes. The computer program may be carried by a computer program product connected to the processor.

The computer program product may comprise a computer readable medium on which the computer program is stored. For example, the computer program product may be a flash memory, a Random-access memory (RAM), a Read-Only Memory (ROM), or an EEPROM, and the computer program modules described above could in alternative embodiments be distributed on different computer program products in the form of memories within the network nodes.

Correspondingly to the method 900 as described above, an exemplary first network node is provided. FIG. 14 is a block diagram of a first network node 1400 according to an embodiment of the present disclosure. The first network node 1400 may be, e.g., the AMF 225 in some embodiments.

The first network node 1400 may be configured to perform the method 900 as described above in connection with FIG. 9. As shown in FIG. 14, the first network node 1400 may comprise a determining module 1410 configured to determine whether the AMF fails to contact one or more RAN nodes for the multicast or broadcast session or not; and a transmitting module 1420 configured to transmit, to the MB-SMF, a first message indicating at least one first RAN node of the one or more RAN nodes in response to determining that the AMF fails to contact the at least one first RAN node for the multicast or broadcast session.

The above modules 1410 and/or 1420 may be implemented as a pure hardware solution or as a combination of software and hardware, e.g., by one or more of: a processor or a micro-processor and adequate software and memory for storing of the software, a Programmable Logic Device (PLD) or other electronic component(s) or processing circuitry configured to perform the actions described above, and illustrated, e.g., in FIG. 9. Further, the first network node 1400 may comprise one or more further modules, each of which may perform any of the steps of the method 900 described with reference to FIG. 9.

Correspondingly to the method 1000 as described above, an exemplary second network node is provided. FIG. 15 is a block diagram of a second network node 1500 according to an embodiment of the present disclosure. The second network node 1500 may be, e.g., the MB-SMF 235 in some embodiments.

The second network node 1500 may be configured to perform the method 1000 as described above in connection with FIG. 10. As shown in FIG. 15, the second network node 1500 may comprise a receiving module 1510 configured to receive, from a first AMF, a first message indicating at least one first RAN node that the first AMF fails to contact for the multicast or broadcast session; a determining module 1520 configured to determine a second AMF that belongs to a same AMF set and/or a same AMF service set as the first AMF does; and a transmitting module 1530 configured to transmit, to the second AMF, a seventh message indicating one or more identifiers of the at least one first RAN node that is to be contacted by the second AMF for performing an operation associated with the multicast or broadcast session.

The above modules 1510, 1520, and/or 1530 may be implemented as a pure hardware solution or as a combination of software and hardware, e.g., by one or more of: a processor or a micro-processor and adequate software and memory for storing of the software, a PLD or other electronic component(s) or processing circuitry configured to perform the actions described above, and illustrated, e.g., in FIG. 10. Further, the second network node 1500 may comprise one or more further modules, each of which may perform any of the steps of the method 1000 described with reference to FIG. 10.

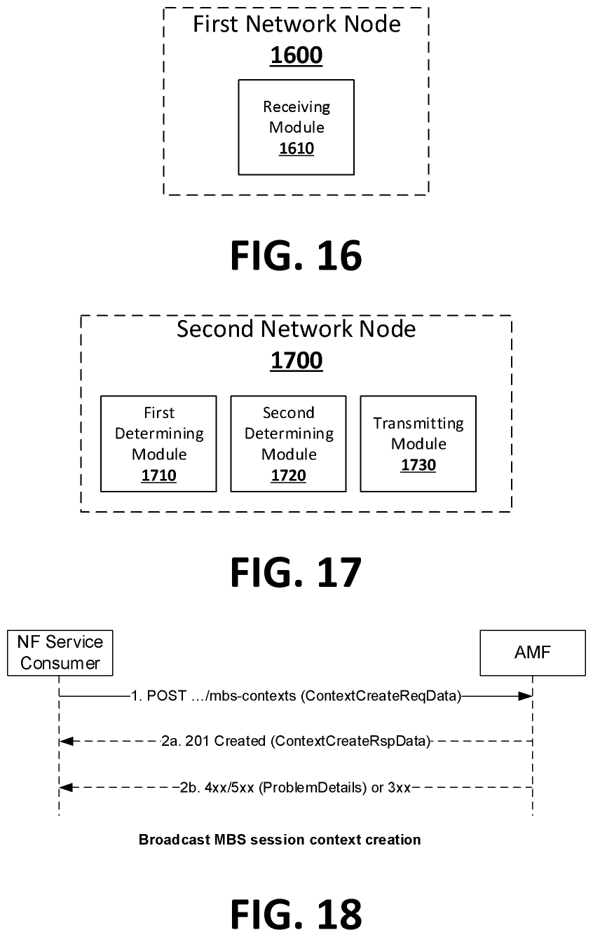

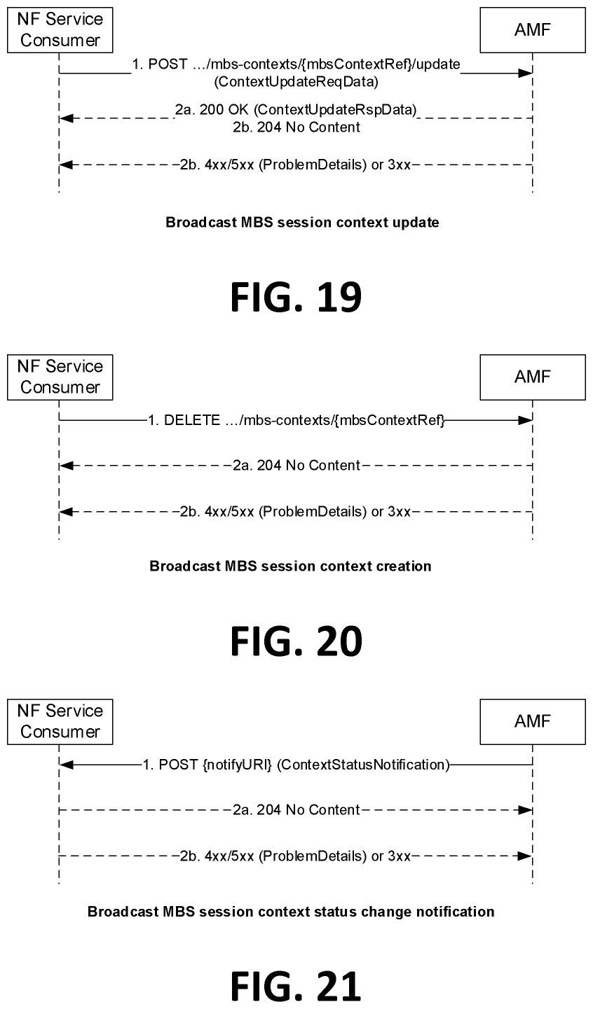

Correspondingly to the method 1100 as described above, an exemplary first network node is provided. FIG. 16 is a block diagram of a first network node 1600 according to an embodiment of the present disclosure. The first network node 1600 may be, e.g., the AMF 225 in some embodiments.

The first network node 1600 may be configured to perform the method 1100 as described above in connection with FIG. 11. As shown in FIG. 16, the first network node 1600 may comprise a receiving module 1610 configured to receive, from the MB-SMF, an eleventh message comprising an indication that the eleventh message is to provide information associated with the broadcast session to be used only for subsequent restoration of the broadcast session when one or more RAN nodes would have restarted.

The above module 1610 may be implemented as a pure hardware solution or as a combination of software and hardware, e.g., by one or more of: a processor or a micro-processor and adequate software and memory for storing of the software, a PLD or other electronic component(s) or processing circuitry configured to perform the actions described above, and illustrated, e.g., in FIG. 11. Further, the first network node 1600 may comprise one or more further modules, each of which may perform any of the steps of the method 1100 described with reference to FIG. 11.

Correspondingly to the method 1200 as described above, an exemplary second network node is provided. FIG. 17 is a block diagram of a second network node 1700 according to an embodiment of the present disclosure. The second network node 1700 may be, e.g., the MB-SMF 235 in some embodiments.

The second network node 1700 may be configured to perform the method 1200 as described above in connection with FIG. 12. As shown in FIG. 17, the second network node 1700 may comprise a first determining module 1710 configured to determine whether a first AMF fails to serve the broadcast session; a second determining module 1720 configured to determine a second AMF to take over the broadcast session from the first AMF; and a transmitting module 1730 configured to transmit, to a second AMF, an eleventh message comprising an indication that the eleventh message is to provide information associated with the broadcast session to be used only for subsequent restoration of the broadcast session when one or more RAN nodes would have restarted.

The above modules 1710, 1720, and/or 1730 may be implemented as a pure hardware solution or as a combination of software and hardware, e.g., by one or more of: a processor or a micro-processor and adequate software and memory for storing of the software, a PLD or other electronic component(s) or processing circuitry configured to perform the actions described above, and illustrated, e.g., in FIG. 12. Further, the second network node 1700 may comprise one or more further modules, each of which may perform any of the steps of the method 1200 described with reference to FIG. 12.

The present disclosure is described above with reference to the embodiments thereof. However, those embodiments are provided just for illustrative purpose, rather than limiting the present disclosure. The scope of the disclosure is defined by the attached claims as well as equivalents thereof. Those skilled in the art can make various alternations and modifications without departing from the scope of the disclosure, which all fall into the scope of the disclosure.

| Abbreviation | Explanation |
|---|---|
| AMF | Access and Mobility Management Function |
| DL | Downlink |
| GTP-U | GPRS Tunnel Protocol - User plane |
| MBS | Multicast/Broadcast Service |
| MB-SMF | Multicast/Broadcast Session Management Function |
| NG-RAN | Next Generation - Radio Access Network |
| SMF | Session Management Function |
| TEID | Tunnel Entity Identity |

1. A method at an AMF for facilitating an MB-SMF in restoring a broadcast session, the method comprising:
receiving, from the MB-SMF, an eleventh message comprising an indication that the eleventh message is to provide information associated with the broadcast session to be used only for subsequent restoration of the broadcast session when one or more RAN nodes would have restarted.

2. The method of claim 1, wherein the eleventh message indicates at least one of:
an identifier of the broadcast session;
a service area associated with the broadcast session;
information required for subsequent restorations of the broadcast session; and
a restoration indication indicating that the AMF is not to trigger any NG Application Protocol signaling to the one or more RAN nodes for restoring the broadcast session.

3. The method of claim 2, wherein when the restoration indication is set to “true” and the service area is indicated by the eleventh message, the AMF is requested to not trigger any NGAP signaling towards one or more NG-RAN nodes covering the indicated service area.

4. The method of claim 1, wherein the AMF and another AMF, which was used for restoration of the broadcast session, belong to a same AMF set and/or a same AMF service set.

5. The method of claim 1, further comprising:
transmitting, to the MB-SMF, a twelfth message acknowledging the eleventh message and indicating that the AMF has taken over the broadcast session from the other AMF.

6. The method of claim 1, wherein the broadcast session is an MBS session.

7. The method of claim 1, where at least one of following is true:
the eleventh message is an Namf_MBSBroadcast_ContextUpdate Request message; and
the twelfth message is an Namf_MBSBroadcast_ContextUpdate Response message.

8. A first network node, comprising:
a processor;
a memory storing instructions which, when executed by the processor, cause the processor to perform operations comprising:
receive, from the MB-SMF, an eleventh message comprising an indication that the eleventh message is to provide information associated with the broadcast session to be used only for subsequent restoration of the broadcast session when one or more RAN nodes would have restarted.

9. The first network node of claim 8, wherein an AMF is hosted at the first network node.

10. A method at an MB-SMF for restoring a broadcast session, the method comprising:
determining whether a first AMF fails to serve the broadcast session;
determining a second AMF to take over the broadcast session from the first AMF; and
transmitting, to a second AMF, an eleventh message comprising an indication that the eleventh message is to provide information associated with the broadcast session to be used only for subsequent restoration of the broadcast session when one or more RAN nodes would have restarted.

11. The method of claim 10, wherein the eleventh message indicates at least one of:
an identifier of the broadcast session;
a service area associated with the broadcast session;
information required by the second AMF for subsequent restorations of the broadcast session; and
a restoration indication indicating that the second AMF is not to trigger any NGAP signaling to the one or more RAN nodes for restoring the broadcast session.

12. The method of claim 11, wherein when the restoration indication is set to “true” and the service area is indicated by the eleventh message, the second AMF is requested to not trigger any NGAP signaling towards one or more NG-RAN nodes covering the indicated service area.

13. The method of claim 10, wherein the first AMF and the second AMF belong to a same AMF set and/or a same AMF service set.

14. The method of claim 10, further comprising:
receiving, from the second AMF, a twelfth message acknowledging the eleventh message and indicating that the second AMF has taken over the broadcast session from the first AMF.

15. The method of claim 10, wherein the step of determining whether a first AMF fails to serve the broadcast session comprises:
detecting whether the first AMF fails to serve the broadcast session by using a Hypertext Transfer Protocol Version 2 (HTTP/2) Ping Frame.

16. The method of claim 10, wherein before the step of determining whether a first AMF fails to serve the broadcast session, the method further comprises:
subscribing, to a Network Repository Function, to receive a notification of a change of a profile of the first AMF,
wherein the step of determining whether a first AMF fails to serve the broadcast session comprises:
receiving, from the NRF, a notification of a change of the profile of the first AMF, which indicates that the first AMF fails to serve the broadcast session.

17. The method of claim 10, wherein the broadcast session is an MBS session.

18. The method of claim 10, where at least one of following is true:
the eleventh message is an Namf_MBSBroadcast_ContextUpdate Request message; and
the twelfth message is an Namf_MBSBroadcast_ContextUpdate Response message.

19. A second network node, comprising:
a processor;
a memory storing instructions which, when executed by the processor, cause the processor to perform operations comprising:
determine whether a first AMF fails to serve the broadcast session;
determine a second AMF to take over the broadcast session from the first AMF; and
transmit, to a second AMF, an eleventh message comprising an indication that the eleventh message is to provide information associated with the broadcast session to be used only for subsequent restoration of the broadcast session when one or more RAN nodes would have restarted.

20. The second network node of claim 19, wherein an MB-SMF is hosted at the second network node.

21.-59. (canceled)
